(19) United States
(12) Patent Application Publication
(10) Pub. No.: US 2026/0311189 A1
(43) Pub. Date: Oct. 8, 2026

(54) PRODUCT RECALL MANAGEMENT

(71) Applicant: Honeywell International Inc., Charlotte, NC (US)

(72) Inventors: Ankit Singh, Apex, NC (US); Waad Subber, Schenectady, NY (US); Lakshminarayana Paila, Frisco, TX (US)

(21) Appl. No.: 19/172,656

(22) Filed: Apr. 8, 2025

(51) Int. Cl. G06Q 30/014

(52) U.S. Cl. CPC G06Q 30/014

(57) ABSTRACT

Approaches for managing product recall effectiveness are described. According to an example, distribution data, that describes movement of various a plurality of units of a product among one or more entities involved in procurement and distribution of the plurality of units in a distribution chain of the product, is obtained. The distribution data is processed to identify a bottleneck entity, from the one or more entities, that are affecting recovery of the plurality of units of the product by an organization. Then, an optimal communication strategy is generated for communicating with the bottleneck entity to enable recovery of the plurality of units of the product by the organization.

### BACKGROUND

Product recalls are a critical aspect of consumer safety and quality control across various industries, including manufacturing, pharmaceuticals, food production, and consumer goods. An organization may initiate a product recall when any product manufactured by the organization is found to be defective, potentially harmful, or non-compliant with regulatory standards. Once the organization has made a decision to recall a product, the organization must swiftly recall and recover distributed units of the recalled product to safeguard lives of consumers of the product and prevent significant reputational and financial damage for the organization. Failure to effectively coordinate the return or disposal of the distributed units of the recalled product may result in severe consequences, including regulatory penalties, legal repercussions, and long-lasting harm to brand trust built by the organization over years.

### BRIEF DESCRIPTION OF FIGURES

Systems and/or methods are now described, in accordance with examples of the present subject matter and with reference to the accompanying figures, in which:

FIG. 1 illustrates a system for managing product recall effectiveness, according to an example;

FIG. 2 illustrates a computing environment implementing the system for managing product recall effectiveness, according to another example;

FIG. 3 illustrates a computing environment implementing the system for managing product recall effectiveness, according to another example;

FIG. 4 illustrates a method for managing product recall effectiveness, according to an example;

FIG. 5 illustrates a method for managing product recall effectiveness, according to another example;

FIG. 6 illustrates a method for managing product recall effectiveness, according to yet another example;

FIG. 7 illustrates a method for managing product recall effectiveness, according to another example;

FIG. 8 illustrates a method for managing product recall effectiveness, according to yet another example;

FIG. 9 illustrates a method for managing product recall effectiveness, according to another example; and

FIG. 10 illustrates a computing environment implementing a non-transitory computer-readable medium for managing product recall effectiveness, according to an example.

### DETAILED DESCRIPTION

In the increasingly complex landscape of global supply chains, various units of a recalled product often pass through numerous entities before reaching end consumers, creating an intricate web of transactions and transfers that includes manufacturers, wholesalers, distributors, and retailers. The complexity of the supply chains of the product poses significant challenges for organizations in managing effectiveness of product recalls. Managing effectiveness of product recalls is vital not only for consumer safety but also for regulatory compliance and mitigating potential legal and financial risks.

Typically, organizations maintain internal records of direct sales and immediate downstream recipients of their products. For recovering distributed units of a product for which a recall decision has been taken, an organization may utilize internal records to identify specific entities, i.e., immediate downstream recipients of the product, that are to be informed about the recall decision. The organization may then issue a recall notice to the specific entities through electronic mails or phone calls to inform the specific entities about the nature of the defect or issue in the product, potential risks associated with the product, and instructions for returning or disposing of the product. Organizations typically rely on a cascade approach to forward the recall notice for returning or disposing of the product, owing to which, the organization may rely on the specific entities to provide the recall notice to next entities, immediately downstream to the specific entities, who received some units of the product from the specific entities. The next entities may be relied on for providing the recall notice to further entities immediately downstream to the next entity, and so on for entire distribution chain of the product, so that all or most of the distributed units of the product may be recovered.

Thus, communication of the instructions to all entities in the distribution chain of the product may be crucial for effectively recovering the distributed units of the product, which is often quantified as a recall effectiveness. The recall effectiveness may be measured as a percentage of total distributed units of the product that are successfully recovered by the organization as shown in equation (1).

$$Recall Effectiveness = ( \frac{Total recovered units of product}{Total distributed units of product} ) \times 100 \qquad equation ( 1 )$$

The recall effectiveness may depend on communication effectiveness which may be a quantitative measure of entities that have been provided with the recall notice. That is, improving the communication effectiveness may improve the recall effectiveness as a greater number of units of the product may be recovered if a greater number of entities may be reached with the recall notice. The communication effectiveness may be measured as a percentage of total entities in the distribution chain that are successfully reached with the recall notice as shown in equation (2).

$$Communication Effectiveness = ( \frac{Number of entities reached}{Total entities} ) \times 100 \qquad equation ( 2 )$$

Improving the recall effectiveness may be important not only for consumer safety but also for regulatory compliance. However, achieving high recall effectiveness can be challenging, particularly when dealing with widely distributed products or complex supply chains. One significant challenge in achieving high recall effectiveness may be the lack of end-to-end visibility throughout the entire distribution chain. While organizations may have detailed information about the immediate downstream recipients, organizations often lack visibility into subsequent distributors, making it difficult to identify all affected parties in a recall scenario. Due to lack of end-to-end visibility, the organizations may not be able to track whether the immediate downstream recipients have any subsequent downstream recipients in the distribution chain. Thus, the organizations may not even be able to monitor the communication effectiveness and may fail to take quick measures for improving the recall effectiveness. Further, reliance on the cascade approach for communication may lead to potential delays or missed notifications.

Therefore, organizations may suffer from lower recovery rates, i.e., lower recall effectiveness, for recalled products. Unrecovered units of recalled products may remain in circulation, potentially leaving consumers exposed to risks associated with defective or harmful items. This may not only jeopardize consumer safety but also exposes organizations to regulatory penalties and reputational damage. As products move through multiple tiers of distributors, wholesalers, and retailers across different geographical regions, tracking and recovering recalled units of the product becomes increasingly difficult. Complexity in the distribution chain may result in communication gaps and potential bottlenecks in the process of recovery of the product, making it challenging for organizations to achieve high levels of recall effectiveness. Thus, there is a need for techniques that facilitate efficient and comprehensive product recovery for improving the recall effectiveness.

The present subject matter describes approaches for managing product recall effectiveness. The approach leverages distribution data, such as electronic product code information services (EPCIS) data, that describes movement of various units, say a plurality of units, of a product among various entities involved in procurement and distribution of the units in a distribution chain of the product. The approach involves processing the distribution data to identify a bottleneck entity, from the one or more entities, that are affecting recovery of the units of the product by the organization. An optimal communication strategy may then be generated for the bottleneck entity, enabling more effective interaction and potentially accelerating the recovery of the units. In case the distribution chain includes a plurality of bottleneck entities, the present subject matter may easily identify each of the plurality of bottleneck entities and tailor an optimal communication strategy for each of the plurality of bottleneck entities. The present subject matter therefore efficiently identifies bottleneck entities even in complex distribution chains and provides targeted communication strategies for communication with the bottleneck entities. By focusing on the most critical points, i.e., the bottleneck entities, in the distribution chain, the present subject matter enhances overall recall effectiveness, reduce potential risks to consumers, and help organizations better meet regulatory requirements and protect their brand reputation during product recall events.

In an example, the optimal communication strategy may indicate one or more optimal communication modes to be used for communicating with the bottleneck entity. In an example, the optimal communication strategy may indicate an optimal re-attempt frequency corresponding to each of the one or more optimal communication modes. In addition, or alternatively, the optimal communication strategy may indicate a suggestion related to use of a third-party for communicating with the bottleneck entity.

In an example, the optimal communication strategy may be tailored based on a geographic location of the bottleneck entity. For tailoring the optimal communication strategy, a particular location to which the bottleneck entity belongs may be identified. Then, real-time information about the particular location may be obtained. Further, pre-defined information associated with the particular location. The real-time information and the pre-defined information may be analyzed to generate the optimal communication strategy.

In an example, the optimal communication strategy may be tailored based on historical behavior of the bottleneck entity. For tailoring the optimal communication strategy, it may be ascertained whether the bottleneck entity was identified as a bottleneck during any historical product recall performed by the organization. Upon ascertaining the bottleneck entity to have been identified as a bottleneck during a historical product recall, historical communication data, describing a historical communication strategy implemented corresponding to the historical product recall for communicating with the bottleneck entity, may be obtained. Further, a current communication strategy initially utilized to communicate with the bottleneck entity when the product is recalled by the organization may be obtained. The current communication strategy and the historical communication strategy may be analyzed to generate the optimal communication strategy for communicating with the bottleneck entity.

In an example, entity data describing each of the one or more entities may be obtained. Each of the one or more entities may be anonymized based on the entity data to generate one or more anonymized entities. The distribution data and the one or more anonymized entities may be processed to generate an anonymized distribution path visually representing the movement of each of the plurality of units among the one or more anonymized entities. The anonymized distribution path may then be rendered on a user interface.

The present subject matter offers significant advantages in managing product recalls, specifically improving effectiveness of product recalls, across complex distribution chains. By identifying bottleneck entities that impede product recovery, the present subject matter allows organizations to focus their efforts and resources precisely where they are most needed. Targeting the bottleneck entities enhances the efficiency of recall operations, potentially reducing the time and cost associated with recovering recalled products. The generation of optimal communication strategies for the bottleneck entities further improves the likelihood of successful product recovery, as it enables more effective and persuasive interactions tailored to specific circumstances. The precision in communication with the bottleneck entities can lead to higher response rates from entities in the distribution chain, ultimately increasing the overall effectiveness of a recall process.

Further, the present subject matter provides a data-driven approach providing organizations with deeper insights into dynamics of the distribution chain during recall events. By processing and analyzing distribution data, the present subject matter can uncover patterns and trends that may not be apparent through traditional recall management techniques. The present subject matter enhances visibility of the organizations into the distribution chain, facilitating more informed decision-making and strategy development in both current and future recall scenarios. The ability to adapt communication strategies based on real-time information and historical performance can further improve the speed of product recovery and the likelihood of a greater number of product units. By rendering anonymized distribution path, valuable insights into the distribution chain may be provided while maintaining privacy of the entities, enabling better strategic planning without compromising sensitive business relationships. Thus, the present subject matter helps organizations to better protect consumer safety, comply with regulatory requirements, and safeguard their brand reputation during recall events.

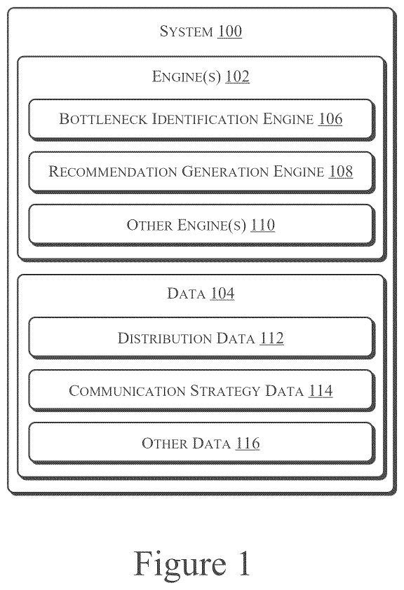

The present subject matter is further described with reference to FIG. 1 to FIG. 10. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 100 for managing product recall effectiveness, according to an example. In one example, the system 100 may be a distributed computing system having one or more physical computing systems geographically distributed at same or different locations. In another example, one or more components of the system 100 may be hosted virtually, for example, on a cloud-based platform, while other components may be geographically distributed at same or different locations. In yet another example, the system 100 may be a stand-alone physical system geographically located at a particular location. In an example, the system 100 may be utilized by users associated with an organization aiming to effectively recall and recover distributed units of a product manufactured by the organization.

In one example, the system 100 may include engine(s) 102 and data 104. The system 100 may also include additional components, such as display, input/output interfaces, operating systems, applications, and other software or hardware components (not shown in the figures).

The engine(s) 102 may be implemented as a combination of hardware and programming, for example, programmable instructions to implement a variety of functionalities of the engine(s) 102. In examples described herein, such combinations of hardware and programming may be implemented in several different ways. For example, the engine(s) 102 may be programmed using executable instructions. Such instructions may be stored on a non-transitory machine-readable storage medium which may be coupled either directly with the system 100 or indirectly (for example, through networked means). In an example, the engine(s) 102 may include a processing resource, for example, either a single processor or a combination of multiple processors, to execute such instructions. In the present examples, the non-transitory machine-readable storage medium may store instructions that, when executed by the processing resource, implement the engine(s) 102. In other examples, the engine(s) 102 may be implemented as electronic circuitry.

In one example, the engine(s) 102 may include a bottleneck identification engine 106, a recommendation generation engine 108, and other engine(s) 110. The other engine(s) 110 may further implement functionalities that supplement functions performed by the system 100 or any of the engine(s) 102.

The data 104 includes data that is either received, stored, or generated as a result of functions implemented by any of the engine(s) 102 or the system 100. It may be further noted that information stored and available in the data 104 may be utilized by the engine(s) 102 for performing various functions of the system 100. The data 104 may include distribution data 112, communication strategy data 114, and other data 116. The distribution data 112 may include data describing movement of various units of each product, manufactured and distributed by the organization, among various entities involved in procurement and distribution of the various units of the product in a distribution chain. Examples of the various entities in the distribution chain may include, but are not limited to, suppliers, national wholesalers, regional wholesalers, independent distributors, retailers, and end consumers of the product. The communication strategy data 114 may include data describing optimal communication strategies generated by the system 100 for enabling effective communication with any of the various entities. The other data 116 may include data that is either received, stored, or generated as a result of functions implemented by any of the engine(s) 102.

In operation, the bottleneck identification engine 106 may receive a bottleneck identification request in relation to a product recall action initiated by an organization to recall a plurality of units of a product. The product recall action may be initiated by the organization upon identifying the product to be defective, potentially harmful, or non-compliant with regulatory standards. In an example, the product recall action may include a recall decision taken by the organization after conducting investigations for assessing the quality of the product. In another example, the product recall action may include an action taken by the organization to issue a recall notice to all entities that are known to the organization and are likely to be affected by the recall decision. The recall notice may include recall-related information, such as the nature of the defect or issue in the product, potential risks associated with the product, and instructions for returning or disposing of the product. In an example, the bottleneck identification request may be triggered by a user associated with the organization to manage recall effectiveness for the product. For example, the user may be a recall manager, associated with a pharmaceutical company, responsible for managing recovery of various units of a particular medicine, such as a blood pressure medication, recalled due to a particular quality concern. The user may interact with a user interface of a software application or a web-based service managed by the system 100, to issue the bottleneck identification request by selecting a particular option on the user interface. The user may interact with the user interface through any electronic device, such as a desktop computer, a laptop, a tablet, a smartphone, and a wearable device. In another example, the bottleneck identification request may be automatically triggered once a pre-defined time interval has passed after initiation of the product recall action by the organization. For example, the bottleneck identification request may be automatically triggered once ten days have passed after initiation of the product recall action to identify bottlenecks affecting recovery of the plurality of units of the product by the organization.

Once the bottleneck identification request is received, the bottleneck identification engine 106 may obtain distribution data describing movement of each of the plurality of units among one or more entities. For example, the distribution data may describe the movement of the blood pressure medication through various wholesalers, pharmacies, and hospitals. The one or more entities may be involved in procurement and distribution of at least one of the plurality of units in a distribution chain of the product. For example, a first primary wholesaler may have procured 10,000 units of the particular medicine and a second primary wholesaler may have procured 20,000 units of the particular medicine from the pharmaceutical company. At a particular time at which the distribution data is obtained, the first primary wholesaler may be in possession of 3,000 units of the particular medicine and may have already distributed 7,000 units of the particular medicine, out of which 4,000 units may have been procured by a first secondary wholesaler and 2,000 units may have been procured by a second secondary wholesaler. At the particular time, the second primary wholesaler may not be in possession of any unit of the particular medicine. The second primary wholesaler may have returned 5,000 units of the particular medicine to the pharmaceutical company after initiation of the product recall action and may have already distributed 15,000 units of the particular medicine, out of which 5,000 units may have been procured by a third secondary wholesaler, 3,000 units may have been procured by a fourth secondary wholesaler, and 7,000 units may have been procured by a fifth secondary wholesaler. The first secondary wholesaler, the second secondary wholesaler, the third secondary wholesaler, the fourth secondary wholesaler, and the fifth secondary wholesaler may hereinafter be collectively referred to as secondary wholesalers. Each of the secondary wholesalers may be individually referred to as a secondary wholesaler. Similar to the first primary wholesaler and the second primary wholesaler, the secondary wholesalers may be in possession of one or more procured units of the particular medicine at the particular time. In addition, or alternatively, one or more of the secondary wholesalers may have returned one or more procured units of the particular medicine directly or indirectly to the pharmaceutical company. In addition, or alternatively, the secondary wholesalers may have distributed procured units of the particular medicine to various retailers. Similarly, the various retailers may or may not be in possession of one or more procured units of the particular medicine at the particular time and may or may not have returned one or more procured units of the particular medicine to the pharmaceutical company. In addition, or alternatively, the various retailers may have distributed one or more procured units of the particular medicine to various end consumers, such as patients. The end consumers may have consumed, may be in possession of, and/or may have returned one or more procured units of the particular medicine.

In an example, the distribution data may be electronic product code information services (EPCIS) data describing “what”, “when”, “where”, “why”, and “how” of the plurality of units of the product as the plurality of units move through the distribution chain among the one or more entities. Thus, the distribution data may include a unique unit identifier uniquely representing a particular unit of the product, a unique product identifier uniquely representing the product, information about the whereabouts of the plurality of units including location and timestamps of at least one of procurement and distribution of any of the plurality of units by each of the one or more entities, and details, such as name and location, associated with each of the one or more entities. In an example, the distribution data may be obtained from an external database that tracks distribution chains of products associated with the organization and stores data describing movement of various units of the products in the distribution chains. In another example, the distribution data may be pre-stored in a memory of the system 100 and may be obtained from the memory. In one example, the distribution data may be stored within the distribution data 112.

Once the distribution data is obtained, the bottleneck identification engine 106 may process the distribution data to identify a bottleneck entity from the one or more entities. The bottleneck entity may be an entity affecting recovery of the plurality of units of the product by the organization. In an example, the bottleneck entity may be an entity which is in possession of at least one unit of the product. In another example, when multiple entities are in possession of at least one unit of the product, the bottleneck entity may be considered as one of the multiple entities which has highest possibility of affecting recovery of the plurality of units. For example, if the first primary wholesaler, the second secondary wholesaler immediately downstream the first primary wholesaler, and four retailers immediately downstream the second secondary wholesaler are in possession of at least one unit of the product, the first primary wholesaler, having 3,000 units of the particular medicine, may be considered as the bottleneck entity as it may be highly likely that either the first primary wholesaler may be unaware about the product recall action and may not have informed the second secondary wholesaler about the product recall action or the first primary wholesaler may have intentionally not informed the second secondary wholesaler about the product recall action. In turn, the second secondary wholesaler may not have informed the four retailers about the product recall action. Thus, the bottleneck identification engine 106 may process the distribution data to identify the first primary wholesaler as the bottleneck entity. Therefore, by processing the distribution data, the bottleneck entity may be effectively identified even in a complex distribution chain.

The recommendation generation engine 108 may then generate an optimal communication strategy for communicating with the bottleneck entity. The optimal communication strategy may be generated for transmission to the user to enable recovery of the plurality of units of the product by the organization. In one example, the optimal communication strategy may be stored within the communication strategy data 114.

The optimal communication strategy may define a communication plan specifically tailored and customized for communicating with the bottleneck entity, directly or indirectly, such that one or more units of the product that are in possession of the bottleneck entity may be recovered quickly and efficiently. For example, the recommendation generation engine 108 may generate an optimal communication strategy specifically tailored for communicating with the first primary wholesaler. In an example, the optimal communication strategy may be generated based on various factors, such as characteristics like preferred communication mode, location, position in the distribution chain, associated with the bottleneck entity; number of entities downstream of the bottleneck entity that may have to be communicated with, context of the product recall action; and responsiveness of the bottleneck entity to historical recall communications. Thus, communicating with the bottleneck entity using the optimal communication strategy may increase overall communication effectiveness and recall effectiveness for recalling and recovering the product.

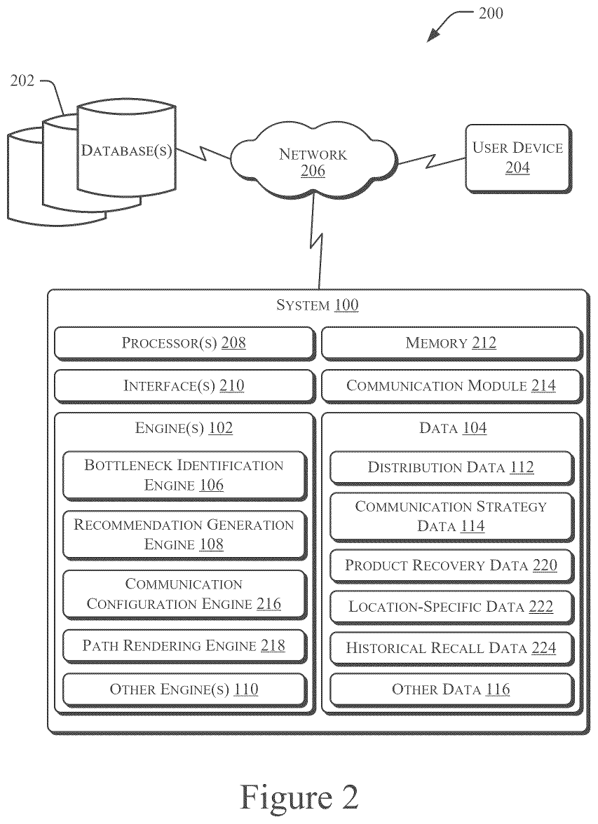

FIG. 2 illustrates a computing environment 200 implementing the system 100 for managing product recall effectiveness, according to another example. In one example, the computing environment 200 may include the system 100, database(s) 202, and a user device 204. The database(s) 202 may be individually referred to as database 202 and collectively referred to as the databases 202. The database 202 may have the capabilities to store data in structured or unstructured formats. The database 202 may serve as a centralized data repository for storing and managing a wide variety of information crucial to the movement of multiple units of products, manufactured and distributed by an organization, through distribution chains involving various entities, such as wholesalers, retailers, and end consumers of the product. For example, the database 202 may capture and maintain real-time detailed records associated with each distributed unit of the products, including information on what, where, when, why, and how of the movement of the distributed unit. In an example, the database 202 may support complex queries, allowing efficient retrieval and analysis of data stored within the database 202. In an example, the database 202 may be a data repository configured to store details of Electronic Product Code Information Services (EPCIS) events. In an example, the database 202 may be a distributed computing system having one or more physical computing systems geographically distributed at same or different locations. In another example, one or more components of the database 202 may be hosted virtually, for example, on a cloud-based platform, while other components may be geographically distributed at same or different locations. In yet another example, the database 202 may be a stand-alone physical system geographically located at a particular location.

In an example, the user device 204 may be any electronic device that allows a user to access, view, and interact with digital information or applications. In an example, the user device 204 may be a device utilized by a user to trigger the system 100 to initiate investigation into bottlenecks affecting recall effectiveness associated with a product. Further, the system 100 may provide various notifications over the user device 204 to notify the user of results of the investigation. Examples of the user device 204 may include, but are not limited to, a smartphone, a laptop, a mobile phone, and a computer. Examples of the user device 204 may also include, but are not limited to, a desktop, a tablet computer, a wearable electronic device, a personal digital assistant (PDA), and any electronic device capable of transmitting or receiving data.

The system 100, the databases 202, and the user device 204 may be communicably coupled with each other over a communication network 206 and may exchange data and signals over the communication network 206. The communication network 206 may be a wireless network, a wired network, or a combination thereof. The communication network 206 may also be an individual network or a collection of many such individual networks, interconnected with each other and functioning as a single large network, e.g., the Internet or an intranet. Examples of such individual networks include local area network (LAN), wide area network (WAN), the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN).

Depending on the technology, the communication network 206 may include various network entities, such as transceivers, gateways, and routers. In an example, the communication network 206 may include any communication network that uses any of the commonly used protocols, for example, Hypertext Transfer Protocol (HTTP), and Transmission Control Protocol/Internet Protocol (TCP/IP).

In one example, the system 100 may include processor(s) 208, interface(s) 210, memory 212, a communication module 214, the engine(s) 102, and the data 104. The system 100 may also include other components, such as display, input/output interfaces, operating systems, applications, and other software or hardware components (not shown in the figures).

The processor(s) 208 may be implemented as microprocessors, microcomputers, microcontrollers, digital signal processors, central processing units, state machines, logic circuitries, and/or other devices that manipulate signals based on operational instructions. The interface(s) 210 may allow the connection or coupling of the system 100 with one or more other devices, such as the databases 202 and the user device 204, through a wired (e.g., Local Area Network, i.e., LAN) connection or through a wireless connection (e.g., Bluetooth®, Wi-Fi). The interface(s) 210 may also enable intercommunication between different logical as well as hardware components of the system 100.

The memory 212 may be a computer-readable medium, examples of which include volatile memory (e.g., RAM), and/or non-volatile memory (e.g., Erasable Programmable read-only memory, i.e., EPROM, flash memory, etc.). The memory 212 may be an external memory or an internal memory, such as a flash drive, a compact disk drive, an external hard disk drive, or the like. The memory 212 may further include the data 104 and/or other data which may either be received, utilized, or generated during the operation of the system 100.

The communication module 214 may be a wireless communication module. Examples of the communication module 214 may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the communication module 214 may also include one or more antennas to enable wireless transmission and reception of data and signals. The communication module 214 may allow the system 100 to transmit data and signals to one or more other devices, such as the databases 202 and the user device 204; and receive data and signals from the one or more other devices.

The engine(s) 102 may include the bottleneck identification engine 106, the recommendation generation engine 108, and the other engine(s) 110, as explained with reference to FIG. 1. The engine(s) 102 may further include a communication configuration engine 216 and a path rendering engine 218.

The data 104 may include the distribution data 112, the communication strategy data 114, and the other data 116, as explained with reference to FIG. 1. In an example, the data 104 may further include product recovery data 220, location-specific data 222, and historical recall data 224. In an example, the product recovery data 220 may include information about various units of a product that have been successfully recovered by the organization from all units of the product distributed by the organization, after the organization decided to recall the product. The location-specific data 222 may include real-time information about one or more geographic locations of the entities identified to be in possession of the product and pre-defined information about the one or more geographic locations. The real-time information may include current weather conditions and local events, such as local festival celebration and a catastrophic event, associated with each of the one or more geographic locations. The pre-defined information may include local regulations, cultural considerations, historical recall performance, and typical business practices specific to each of the one or more geographic locations. The historical recall data 224 may include information about historical product recalls conducted by the organization, encompassing details such as the effectiveness of the historical product recalls, response times of various entities in distribution chains of recalled products associated with the historical product recalls, communication strategies used to communicate with the various entities during the historical product recalls, and the performance of the various entities in returning the recalled products.

In operation, the bottleneck identification engine 106 may receive a bottleneck identification request in relation to a product recall action initiated by an organization to recall a plurality of units of a product. The product recall action may be initiated by the organization upon identifying the product to be defective, potentially harmful, or non-compliant with regulatory standards. In an example, the product recall action may include a recall decision taken by the organization after conducting investigations for assessing the quality of the product. In another example, the product recall action may include an action taken by the organization to issue a recall notice to all entities that are known to the organization and are likely to be affected by the recall decision. The recall notice may include recall-related information, such as the nature of the defect or issue in the product, potential risks associated with the product, and instructions for returning or disposing of the product. In an example, the bottleneck identification request may be triggered by a user associated with the organization to manage recall effectiveness for the product. For example, the user may be a recall manager, associated with a pharmaceutical company, responsible for managing recovery of various units of a particular medicine, such as a blood pressure medication, recalled due to a particular quality concern. The user may interact with a user interface of a software application or a web-based service managed by the system 100, to issue the bottleneck identification request by selecting a particular option on the user interface. The user may interact with the user interface through the user device 204. In another example, the bottleneck identification request may be automatically triggered once a pre-defined time interval has passed after initiation of the product recall action by the organization. For example, the bottleneck identification request may be automatically triggered once ten days have passed after initiation of the product recall action to identify bottlenecks affecting recovery of the plurality of units of the product by the organization.

Upon receiving the bottleneck identification request, the bottleneck identification engine 106 may obtain distribution data describing movement of each of the plurality of units among one or more entities. For example, the distribution data may describe the movement of the blood pressure medication through various wholesalers, pharmacies, and hospitals. The one or more entities may be involved in procurement and distribution of at least one of the plurality of units in a distribution chain of the product. For example, a first primary wholesaler may have procured 10,000 units of the particular medicine and a second primary wholesaler may have procured 20,000 units of the particular medicine from the pharmaceutical company. At a particular time at which the distribution data is obtained, the first primary wholesaler may be in possession of 3,000 units of the particular medicine and may have already distributed 7,000 units of the particular medicine, out of which 4,000 units may have been procured by a first secondary wholesaler and 2,000 units may have been procured by a second secondary wholesaler. At the particular time, the second primary wholesaler may not be in possession of any unit of the particular medicine. The second primary wholesaler may have returned 5,000 units of the particular medicine to the pharmaceutical company after initiation of the product recall action and may have already distributed 15,000 units of the particular medicine, out of which 5,000 units may have been procured by a third secondary wholesaler, 3,000 units may have been procured by a fourth secondary wholesaler, and 7,000 units may have been procured by a fifth secondary wholesaler. The first secondary wholesaler, the second secondary wholesaler, the third secondary wholesaler, the fourth secondary wholesaler, and the fifth secondary wholesaler may hereinafter be collectively referred to as secondary wholesalers. Each of the secondary wholesalers may be individually referred to as a secondary wholesaler. Similar to the first primary wholesaler and the second primary wholesaler, the secondary wholesalers may be in possession of one or more procured units of the particular medicine at the particular time. In addition, or alternatively, one or more of the secondary wholesalers may have returned one or more procured units of the particular medicine directly or indirectly to the pharmaceutical company. In addition, or alternatively, the secondary wholesalers may have distributed procured units of the particular medicine to various retailers. Similarly, the various retailers may or may not be in possession of one or more procured units of the particular medicine at the particular time and may or may not have returned one or more procured units of the particular medicine to the pharmaceutical company. In addition, or alternatively, the various retailers may have distributed one or more procured units of the particular medicine to various end consumers, such as patients. The end consumers may have consumed, may be in possession of, and/or may have returned one or more procured units of the particular medicine.

In an example, the distribution data may be electronic product code information services (EPCIS) data describing “what”, “when”, “where”, “why”, and “how” of the plurality of units of the product as the plurality of units move through the distribution chain among the one or more entities. Thus, the distribution data may include a unique unit identifier uniquely representing a particular unit of the product, a unique product identifier uniquely representing the product, information about the whereabouts of the plurality of units including location and timestamps of at least one of procurement and distribution of any of the plurality of units by each of the one or more entities, and details, such as name and location, associated with each of the one or more entities. In an example, the distribution data may be obtained directly from the databases 202. In another example, the distribution data may be pre-stored in the memory 212 after retrieving the distribution data from the databases 202 and may be obtained from the memory 212. In one example, the distribution data may be stored within the distribution data 112.

In addition, or alternatively, the bottleneck identification engine 106 may obtain product recovery data associated with the product recall action. The product recovery data may indicate details, such as unique identifiers, of one or more units of the product pending to be recovered from the plurality of units. The organization may maintain a record of details of the plurality of units that were distributed and details of particular units that have been recovered by the organization. The details of the plurality of units and the details of the particular units may be compared to identify the one or more units of the product that are pending to be recovered and generate the product recovery data. For example, details of 30,000 units of the particular medicine distributed by the pharmaceutical company may be compared with details of 10,000 units of the particular medicine recovered by the organization to generate the product recovery data including details of 20,000 units of the product pending to be recovered by the organization. In an example, the product recovery data may be obtained from an external database managing details of the one or more units of the product pending to be recovered by the organization. In another example, the product recovery data may be generated and pre-stored in the memory 212 by the system 100 and may be obtained from the memory 212 by the bottleneck identification engine 106. In one example, the product recovery data may be stored within the product recovery data 220.

The bottleneck identification engine 106 may process the distribution data and the product recovery data to identify a bottleneck entity from the one or more entities. The bottleneck entity may be an entity affecting recovery of the plurality of units of the product by the organization. For identifying the bottleneck entity, the distribution data and the product recovery data may be processed to identify which of the one or more entities satisfy one or more pre-determined conditions for qualifying as the bottleneck entity. Examples of the one or more pre-determined conditions for qualifying as the bottleneck entity may include, but are not limited to, a threshold number of units of the product that should be in possession of an entity, and a potential downstream impact of an entity based on a position of the entity in the distribution chain. For example, a primary wholesaler which has a significant downstream impact for having multiple secondary wholesalers, retailers, and end consumers downstream in the distribution chain, and which is determined to be in possession of at least 100 units of the product may be considered as the bottleneck entity.

For identifying the bottleneck entity, the bottleneck identification engine 106 may ascertain whether any entity of the one or more entities is in possession of at least one unit, from the plurality of units of the product. The bottleneck identification engine 106 may analyze the distribution data and the product recovery data to ascertain whether any entity of the one or more entities is in possession of the at least one unit. In case none of the one or more entities are identified to be in possession of at least one unit of the product, the bottleneck identification engine 106 may generate a successful recall notification indicating successful recovery of the plurality of units of the product by the organization. The successful recall notification may be transmitted to the user device 204.

In one example, the bottleneck identification engine 106 may designate each of the one or more entities ascertained to be in possession of at least one unit of the product as the bottleneck entity.

In another example, upon ascertaining a particular entity, of the one or more entities, to be in possession of at least one unit of the product, the bottleneck identification engine 106 may determine the particular entity to be one of one or more probable bottleneck entities affecting the recovery of the plurality of units. For example, if the first primary wholesaler, the second secondary wholesaler immediately downstream to the first primary wholesaler, and four retailers immediately downstream to the second secondary wholesaler possess at least one unit of the product, each of the first primary wholesaler, the second secondary wholesaler, and the four retailers may be determined to be probable bottleneck entities. If the one or more probable bottleneck entities include a single entity, the bottleneck identification engine 106 may designate the single entity as the bottleneck entity.

However, when the one or more probable bottleneck entities include multiple entities, the bottleneck identification engine 106 may determine a specific entity, from the one or more probable bottleneck entities, having a highest precedence in the distribution chain amongst the one or more probable bottleneck entities. The bottleneck identification engine 106 may designate the specific entity as the bottleneck entity. For example, since the first primary wholesaler has a highest precedence amongst the first primary wholesaler, the second secondary wholesaler, and the four retailers being at a top-most position in the distribution chain, the first primary wholesaler may be selected as the bottleneck entity. Thus, the bottleneck entity may be considered as one of the multiple entities which has the highest possibility of affecting recovery of the plurality of units. For example, the first primary wholesaler, having 3,000 units of the particular medicine, may be considered as the bottleneck entity as it may be highly likely that either the first primary wholesaler may be unaware about the product recall action and may not have informed the second secondary wholesaler about the product recall action or the first primary wholesaler may have intentionally not informed the second secondary wholesaler about the product recall action. In turn, the second secondary wholesaler may not have informed the four retailers about the product recall action. Thus, the bottleneck identification engine 106 may process the distribution data and the product recovery data to identify the first primary wholesaler as the bottleneck entity. Therefore, by processing the distribution data and the product recovery data, the bottleneck entity may be effectively identified even in a complex distribution chain.

Once the bottleneck identity is identified, the recommendation generation engine 108 may generate an optimal communication strategy for communicating with the bottleneck entity. The optimal communication strategy may be generated for transmission to the user to enable recovery of the plurality of units of the product by the organization. In one example, the optimal communication strategy may be stored within the communication strategy data 114.

The optimal communication strategy may define a communication plan specifically tailored and customized for communicating with the bottleneck entity, directly or indirectly, such that various units of the product that are in possession of the bottleneck entity may be recovered quickly and efficiently. For example, the recommendation generation engine 108 may generate an optimal communication strategy specifically tailored for communicating with the first primary wholesaler. In an example, the optimal communication strategy may be generated based on various factors such as characteristics, such as preferred communication mode, location, and position in the distribution chain, associated with the bottleneck entity, context of the product recall action, and responsiveness of the bottleneck entity to historical recall communications. Thus, communicating with the bottleneck entity using the optimal communication strategy may increase overall communication effectiveness and recall effectiveness for recalling and recovering the product.

In an example, the optimal communication strategy may indicate one or more optimal communication modes to be used for communicating with the bottleneck entity. For example, a first optimal communication strategy corresponding to a first bottleneck entity may indicate that electronic mail (email) is an optimal communication mode for communicating with the first bottleneck entity. Further, a second optimal communication strategy corresponding to a second bottleneck entity may indicate that physical mail, short message service (SMS), and a phone call are optimal communication modes for communicating with the second bottleneck entity.

In an example, the optimal communication strategy may indicate an optimal re-attempt frequency corresponding to each of the one or more optimal communication modes. For example, the first optimal communication strategy may indicate that, in case any unit pending at the first bottleneck entity is not recovered, re-attempting and sending the email three times may be useful for recovering the pending unit from the first bottleneck entity. Further, the second optimal communication strategy may indicate that, in case any unit pending at the second bottleneck entity is not recovered, re-attempting and sending the physical email two times, the SMS three times, and the phone call five times may be useful for recovering the pending unit from the second bottleneck entity.

In addition, or alternatively, the optimal communication strategy may indicate a suggestion related to use of a third-party for communicating with the bottleneck entity. For example, the first optimal communication strategy may indicate that a particular third-party may be used for effectively recovering the pending unit from the first bottleneck entity, instead of communicating with the first bottleneck entity directly. Further, the second optimal communication strategy may indicate that another third-party may be used for effectively recovering the pending unit from the second bottleneck entity, instead of communicating with the second bottleneck entity directly.

In an example, the recommendation generation engine 108 may generate an optimal communication strategy corresponding to each of the one or more probable bottleneck entities in addition to the bottleneck entity so that a greater number of units of the product may be recovered.

In an example, the optimal communication strategy may be generated taking into account confidentiality and anonymity agreements between the one or more entities and one or more third-parties managing the databases 202 which tracks distribution chains of products associated with the organization and stores data, i.e., the distribution data, describing movement of various units of the products in the distribution chains. Thus, while generating the optimal communication strategy, the recommendation generation engine 108 may utilize permitted communication channels according to the confidentiality and anonymity agreements associated with the bottleneck entity and various entities downstream to the bottleneck entity in the distribution chain. For example, if a confidentiality and anonymity agreement associated with the bottleneck entity indicates the bottleneck entity is not to be communicated using any personal information, the optimal communication strategy for communicating with the bottleneck entity may include broadcasting the recall notice through general communication modes, such as press releases, television advertisements, and social media announcements.

In an example, the optimal communication strategy may be tailored based on a geographic location of the bottleneck entity. For tailoring the optimal communication strategy, the recommendation generation engine 108 may identify a particular location to which the bottleneck entity belongs. For example, the first primary wholesaler, designated as the bottleneck entity, may be identified to be based in Germany. In an example, the particular location may be identified based on details of the bottleneck entity included in the distribution data.

Then, the recommendation generation engine 108 may obtain real-time information about the particular location. The real-time information may include current weather conditions and local events, such as local festival celebration and a catastrophic event, associated with the particular location. In an example, the real-time information may be obtained from the user. In another example, the real-time information may be obtained from external sources, for example, by conducting a web-based search about the particular location over the internet. In yet another example, the real-time information may be pre-stored in the memory 212 and may be obtained from the memory 212. In one example, the real-time information may be stored within the location-specific data 222.

Further, the recommendation generation engine 108 may obtain pre-defined information associated with the particular location. The pre-defined information may include local regulations, cultural considerations, historical recall performance, and typical business practices specific to the particular location. In an example, the pre-defined information may be obtained from the user. In another example, the pre-defined information may be obtained from external sources, for example, by conducting a web-based search about the particular location over the internet. In yet another example, the pre-defined information may be pre-stored in the memory 212 and may be obtained from the memory 212. In one example, the pre-defined information may be stored within the location-specific data 222.

The recommendation generation engine 108 may analyze the real-time information and the pre-defined information to generate the optimal communication strategy. For example, if the real-time information indicates that the particular location, at which at least one unit of the product is pending, is in a war situation or the particular location is dealing with after-effects of a catastrophic event, the optimal communication strategy may indicate that an optimal communication mode may be a news article or other broadcasting means instead of using SMS and phone calls. Further, if the pre-defined information indicates third-parties at the particular location, say Germany, do not prefer to work in an ongoing month, the optimal communication strategy may indicate that using a third party from another location may be more efficient for communicating with the bottleneck entity during the ongoing month rather than using a third party belonging to the particular location. Additionally, or alternately, news article, SMS, or other broadcasting means may be used for communicating with the bottleneck entity during the ongoing month. Thus, both the real-time information and the pre-defined information about the particular location may be utilized for generating the optimal communication strategy.

In an example, the optimal communication strategy may be tailored based on historical behavior of the bottleneck entity. For tailoring the optimal communication strategy, the communication configuration engine 216 may ascertain whether the bottleneck entity was identified as a bottleneck during any historical product recall performed by the organization. For ascertaining whether the bottleneck entity was identified as a bottleneck during any historical product recall, the communication configuration engine 216 may obtain and analyze historical recall data describing the historical product recalls conducted by the organization. The historical recall data may include unique identifiers of specific entities identified as bottleneck during the historical product recalls. Thus, a unique identifier of the bottleneck entity may be compared with the unique identifiers of the specific entities to ascertain whether the bottleneck entity was identified as a bottleneck during any of the historical product recalls. In an example, the historical recall data may be obtained from an external database managing records of the historical product recalls conducted by the organization. In another example, the historical recall data may be pre-stored in the memory 212 and may be obtained from the memory 212. In one example, the historical recall data may be stored within the historical recall data 224.

Upon ascertaining the bottleneck entity to have been identified as a bottleneck during a historical product recall, the communication configuration engine 216 may obtain historical communication data describing a historical communication strategy implemented corresponding to the historical product recall for communicating with the bottleneck entity. The historical communication strategy may indicate at least one of communication modes used for communicating with the bottleneck entity during the historical product recall, number of re-attempts made corresponding to each of the communication modes, details of a specific third-party utilized for communicating with the bottleneck entity during the historical product recall. In an example, the historical communication data may be obtained from the external database managing records of the historical product recalls conducted by the organization. In another example, the historical communication data may be pre-stored in the memory 212 and may be obtained from the memory 212. In one example, the historical communication data may be stored within the historical recall data 224.

The communication configuration engine 216 may further obtain a current communication strategy initially utilized to communicate with the bottleneck entity when the product is recalled by the organization. The current communication strategy may indicate at least one of current communication modes used for communicating with the bottleneck entity, number of re-attempts made corresponding to each of the current communication modes, details of a specific third-party utilized for communicating with the bottleneck entity. In an example, the current communication strategy may be obtained from the user. In another example, the current communication strategy may be pre-stored in the memory 212 and may be obtained from the memory 212. In one example, the current communication strategy may be stored within the communication strategy data 114.

The communication configuration engine 216 may analyze the current communication strategy and the historical communication strategy to generate the optimal communication strategy for communicating with the bottleneck entity. For example, the historical communication strategy may indicate that the bottleneck entity did not return pending product units when the bottleneck entity was communicated through an email as a communication mode, but the bottleneck entity returned the pending product units when a phone call was used as a communication mode. Thus, if the current communication strategy does not include a phone call as a communication mode, the optimal communication strategy may be generated so as to indicate a phone call as an optimal communication mode. Similarly, the optimal re-attempt frequency and the suggestion related to use of a third-party may be decided based on the analysis of the current communication strategy and the historical communication strategy.

In an example, the path rendering engine 218 may process the distribution data to generate a distribution path associated with the product. The distribution path may be a visual representation of the movement of each of the plurality of units among the one or more entities. For example, the distribution path may be a tree-like structure, where a root node, i.e., a topmost node, may be a manufacturer of the product and child nodes, downstream to the root node, may be the one or more entities. The tree-like structure may represent the movement of each of the plurality of units from the root node to the one or more entities and the movement of each of the plurality of units among the one or more entities. The path rendering engine 218 may render the distribution path on a user interface. In an example, the user interface may be accessed by the user through the user device 204.

In another example, before rendering the distribution path, the path rendering engine 218 may obtain entity data describing each of the one or more entities. The entity data may include details such as name and location of each of the one or more entities. In an example, the entity data may be included in the distribution data and may thus be obtained directly from the databases 202. In another example, the entity data may be pre-stored in the memory 212 after retrieving the entity data from the databases 202 and may be obtained from the memory 212. In one example, the entity data may be stored within the distribution data 112.

The path rendering engine 218 may anonymize each of the one or more entities based on the entity data to generate one or more anonymized entities. For example, if a particular entity having name “ABC” is based in Germany, an anonymized version of the particular entity may be “Germany-based entity”.

The path rendering engine 218 may process the distribution data and the one or more anonymized entities to generate an anonymized distribution path visually representing the movement of each of the plurality of units among the one or more anonymized entities. For example, the anonymized distribution path may be a tree-like structure, where a root node, i.e., a topmost node, may be a manufacturer of the product and child nodes, downstream to the root node, may be the one or more anonymized entities. The tree-like structure may represent the movement of each of the plurality of units from the root node to the one or more anonymized entities and the movement of each of the plurality of units among the one or more anonymized entities. Thus, instead of using real-identities of the one or more entities, anonymized identities of the one or more entities may be used in the anonymized distribution path.

The path rendering engine 218 may then render the anonymized distribution path on a user interface. In an example, the user interface may be accessed by the user through the user device 204. Thus, instead of revealing the real-identities of the one or more entities to the user, the user may be presented with the anonymized distribution path. For example, entity data may indicate a geographic location of each of the one or more entities and the anonymized distribution path may indicate how the plurality of units moved between entities at different geographic locations without revealing the real identities of the one or more entities. The present subject matter thus offers significant advantages in managing product recalls, specifically improving effectiveness of product recalls, across complex distribution chains.

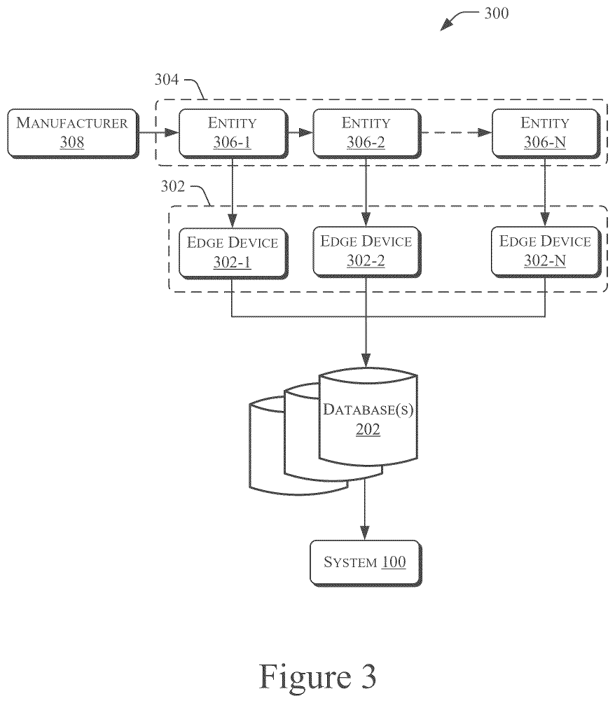

FIG. 3 illustrates a computing environment 300 implementing the system 100 for managing product recall effectiveness, according to another example. In one example, the computing environment 300 may include the system 100, the database(s) 202, and edge device(s) 302-1, 302-2, . . . , 302-N, where N may be a natural number. The edge device(s) 302-1, 302-2, . . . , 302-N may be individually referred to as edge device 302 and collectively referred to as edge devices 302. The edge device 302 may have the capabilities to capture distribution data describing movement of each of a plurality of units of a product in a distribution chain 304. The distribution chain 304 may include one or more entities 306-1, 306-2, . . . , 306-N involved in procurement and distribution of at least one of the plurality of units, where N may be a natural number. The one or more entities 306-1, 306-2, . . . , 306-N may be individually referred to as entity 306 and collectively referred to as entities 306. Examples of the edge device(s) 302 may include, but are not limited to, barcode scanner, Radio Frequency Identification (RFID) readers, smartphones, tablets, or any other electronic device equipped with code scanning capabilities. Examples of the entities 306 may include, but are not limited to, wholesalers, retailers, and end consumers of the product.

The entities 306 within the distribution chain 304 may obtain the plurality of units of the product, directly or indirectly, from a manufacturer 308 of the product. The distribution data may include details of procurement and distribution events performed by the entities 306 for procurement and distribution of at least one of the plurality of units.

In operation, each edge device 302 may track and capture the procurement and distribution events performed by a corresponding entity 306. For example, a first entity 306-1 in the distribution chain 304 may procure 10,000 units of a particular medicine, such as a blood pressure medication, from the manufacturer 308, such as a pharmaceutical company. Procurement of the 10,000 units by the first entity 306-1 may be captured by a first edge device 302-1, upon scanning of a scannable code on each of the 10,000 units or one or more combined scannable codes, such as a code present on a box storing the 10,000 units. Further, the first entity 306-1 may distribute 7,000 units of the particular medicine and distribution, i.e., sending out, of the 7,000 units by the first entity 306-1 may be captured by the first edge device 302-1. Similarly, procurement of 7,000 units of the particular medicine, distributed by the first entity 306-1, by a second entity 306-2 in the distribution chain 304 may be captured by a second edge device 302-2. Thus, the second edge device 302-2 may capture the procurement and distribution events performed by the second entity 306-2. Similarly, a N^{th} edge device 302-N in the distribution chain 306-N may capture the procurement and distribution events performed by the N^{th} entity 306-N.

Thus, the distribution data, including details of the procurement and distribution events, may be electronic product code information services (EPCIS) data describing “what”, “when”, “where”, “why”, and “how” of the plurality of units of the product as the plurality of units move through the distribution chain 304 among the entities 306. The distribution data may include a unique unit identifier uniquely representing a particular unit of the product, a unique product identifier uniquely representing the product, information about the whereabouts of the plurality of units including location and timestamps of at least one of procurement and distribution of any of the plurality of units by each of the entities 306, and details, such as name and location, associated with each of the entities 306.

Each edge device 302 may then transmit details of the captured procurement and distribution events to the database 202. The database 202 may thus store the distribution data that includes the details of the procurement and distribution events captured by the edge device 302. The system 100 may retrieve the distribution data from the database 202 to identify bottleneck entities, from the entities 306, in the distribution chain 304 and devise communication strategies for communicating with the bottleneck entities, as explained with reference to FIG. 2.

Although one edge device has been depicted in FIG. 3 to capture the procurement and distribution events performed by an entity, the present subject matter may be applicable to any number of edge devices capturing the procurement and distribution events performed by the entity. Moreover, although different edge devices have been depicted in FIG. 3 for capturing the procurement and distribution events performed by different entities, the present subject matter may be applicable to a single edge device capturing the procurement and distribution events for multiple entities. Thus, although the number of the edge devices 302 is same as the number of the entities 306 in FIG. 3, the present subject matter may be applicable to scenarios where the number of edge devices is different than the number of entities. Further, although the distribution chain 304 has been depicted as a linear chain of the entities 306, the present subject matter may also be applicable to distribution chains having other structures, such as a tree-like structure, connecting various entities.

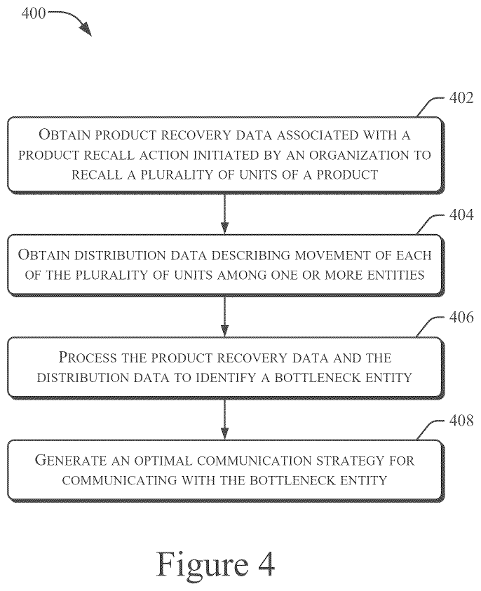

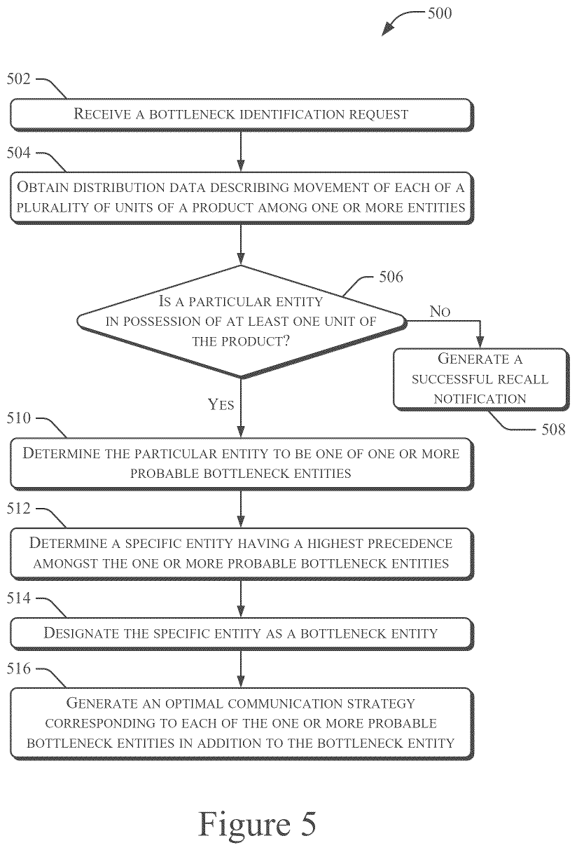

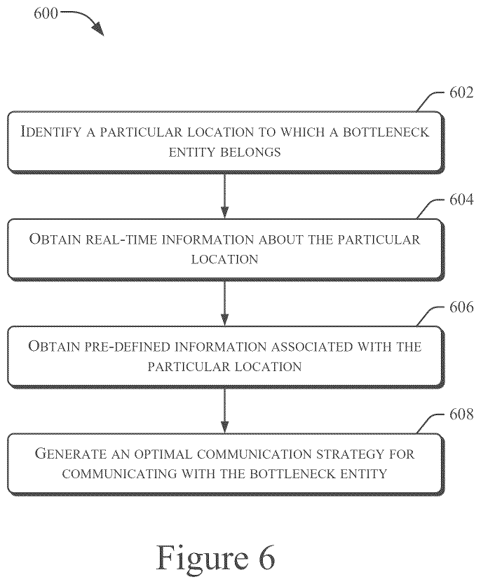

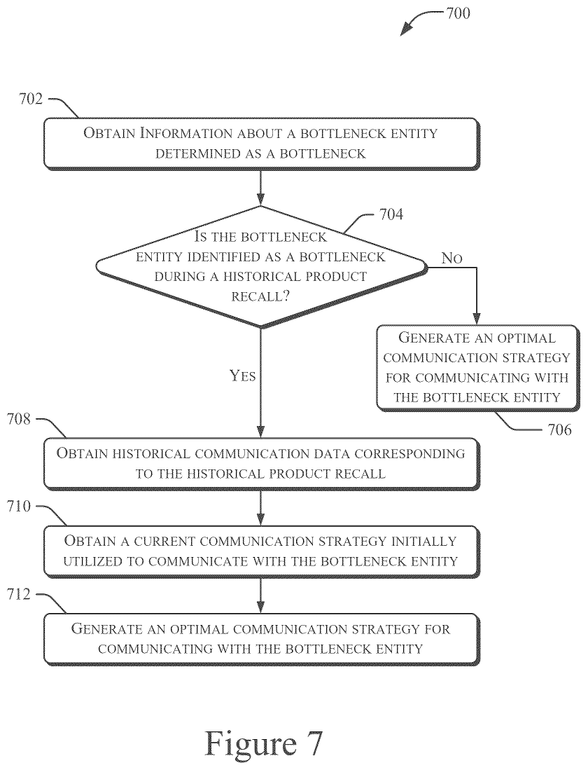

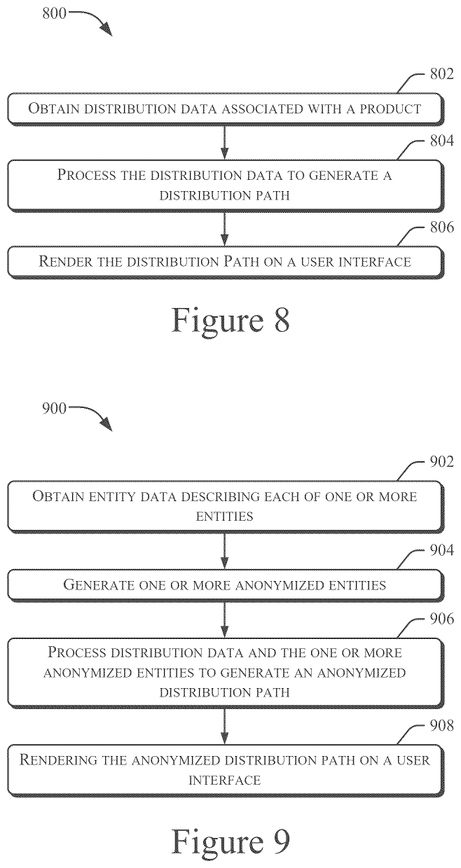

FIG. 4, FIG. 5, FIG. 6, FIG. 7, FIG. 8, and FIG. 9 illustrate example methods 400, 500, 600, 700, 800, and 900, respectively, for managing effectiveness of a product recall. The order in which the methods are described is not intended to be construed as a limitation, and any number of the described method blocks may be combined in any order to implement the methods, or an alternative method. Further, the methods 400, 500, 600, 700, 800, and 900 may be implemented by processing resource or computing device(s) through any suitable hardware, non-transitory machine-readable instructions, or combination thereof.

It may also be understood that methods 400, 500, 600, 700, 800, and 900 may be performed by programmed computing devices, such as the system 100, as depicted in FIG. 1, FIG. 2, and FIG. 3. Furthermore, the methods 400, 500, 600, 700, 800, and 900 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the methods 400, 500, 600, 700, 800, and 900 are described below with reference to the system 100 as described above; other suitable systems for the execution of these methods may also be utilized. Additionally, implementation of the methods 400, 500, 600, 700, 800, and 900 is not limited to such examples.

FIG. 4 illustrates the method 400 for managing product recall effectiveness, according to an example.

At block 402, product recovery data associated with a product recall action initiated by an organization to recall a plurality of units of a product may be obtained. The product recall action may be initiated by the organization upon identifying a product to be defective, potentially harmful, or non-compliant with regulatory standards. In an example, the product recall action may include a recall decision taken by the organization after conducting investigations for assessing the quality of the product. In another example, the product recall action may include an action taken by the organization to issue a recall notice to all entities that are known to the organization and are likely to be affected by the recall decision. The recall notice may include recall-related information, such as the nature of the defect or issue in the product, potential risks associated with the product, and instructions for returning or disposing of the product. In an example, a user associated with the organization may trigger the recall of the plurality of units of the product. For example, the user may be a recall manager, associated with a pharmaceutical company, responsible for managing recovery of various units of a particular medicine, such as a blood pressure medication, recalled due to a particular quality concern.

The product recovery data may indicate details, such as unique identifiers, of one or more units of the product pending to be recovered from the plurality of units. The organization may maintain a record of details of the plurality of units that were distributed and details of particular units that have been recovered by the organization. The details of the plurality of units and the details of the particular units may be compared to identify the one or more units of the product that are pending to be recovered and generate the product recovery data. For example, details of 30,000 units of the particular medicine distributed by the pharmaceutical company may be compared with details of 10,000 units of the particular medicine recovered by the organization to generate the product recovery data including details of 20,000 units of the product pending to be recovered by the organization. In an example, the product recovery data may be obtained from an external database managing details of the one or more units of the product pending to be recovered by the organization. In another example, the product recovery data may be generated and pre-stored in a memory, say the memory 212, by the system 100 and may be obtained from the memory.

At block 404, distribution data describing movement of each of the plurality of units among one or more entities may be obtained. For example, the distribution data may describe the movement of the blood pressure medication through various wholesalers, pharmacies, and hospitals. The one or more entities may be involved in procurement and distribution of at least one of the plurality of units in a distribution chain of the product. For example, a first primary wholesaler may have procured 10,000 units of the particular medicine and a second primary wholesaler may have procured 20,000 units of the particular medicine from the pharmaceutical company. At a particular time at which the distribution data is obtained, the first primary wholesaler may be in possession of 3,000 units of the particular medicine and may have already distributed 7,000 units of the particular medicine, out of which 5,000 units may have been procured by a first secondary wholesaler and 2,000 units may have been procured by a second secondary wholesaler. At the particular time, the second primary wholesaler may not be in possession of any unit of the particular medicine. The second primary wholesaler may have returned 5,000 units of the particular medicine to the pharmaceutical company after initiation of the product recall action and may have already distributed 15,000 units of the particular medicine, out of which 5,000 units may have been procured by a third secondary wholesaler, 3,000 units may have been procured by a fourth secondary wholesaler, and 7,000 units may have been procured by a fifth secondary wholesaler. The first secondary wholesaler, the second secondary wholesaler, the third secondary wholesaler, the fourth secondary wholesaler, and the fifth secondary wholesaler may hereinafter be collectively referred to as secondary wholesalers. Each of the secondary wholesalers may be individually referred to as a secondary wholesaler. Similar to the first primary wholesaler and the second primary wholesaler, the secondary wholesalers may be in possession of one or more procured units of the particular medicine at the particular time. In addition, or alternatively, one or more of the secondary wholesalers may have returned one or more procured units of the particular medicine directly or indirectly to the pharmaceutical company. In addition, or alternatively, the secondary wholesalers may have distributed procured units of the particular medicine to various retailers. Similarly, the various retailers may or may not be in possession of one or more procured units of the particular medicine at the particular time and may or may not have returned one or more procured units of the particular medicine to the pharmaceutical company. In addition, or alternatively, the various retailers may have distributed one or more procured units of the particular medicine to various end consumers, such as patients. The end consumers may have consumed, may be in possession of, and/or may have returned one or more procured units of the particular medicine.

In an example, the distribution data may be electronic product code information services (EPCIS) data describing “what”, “when”, “where”, “why”, and “how” of the plurality of units of the product as the plurality of units move through the distribution chain among the one or more entities. Thus, the distribution data may include a unique unit identifier uniquely representing a particular unit of the product, a unique product identifier uniquely representing the product, information about the whereabouts of the plurality of units including location and timestamps of at least one of procurement and distribution of any of the plurality of units by each of the one or more entities, and details, such as name and location, associated with each of the one or more entities. In an example, the distribution data may be obtained from an external database, say the database 202, that tracks distribution chains of products associated with the organization and stores data describing movement of various units of the products in the distribution chains. In another example, the distribution data may be pre-stored in the memory of the system 100 and may be obtained from the memory.

At block 406, the product recovery data and the distribution data may be processed to identify a bottleneck entity from the one or more entities. The bottleneck entity may be an entity affecting recovery of the plurality of units of the product by the organization. For identifying the bottleneck entity, the distribution data and the product recovery data may be processed to identify which of the one or more entities satisfy one or more pre-determined conditions for qualifying as the bottleneck entity. Examples of the one or more pre-determined conditions for qualifying as the bottleneck entity may include, but are not limited to, a threshold number of units of the product that should be in possession of an entity, and a potential downstream impact of an entity based on a position of the entity in the distribution chain. For example, a primary wholesaler which has a significant downstream impact for having multiple secondary wholesalers, retailers, and end consumers downstream in the distribution chain, and which is determined to be in possession of at least 100 units of the product may be considered as the bottleneck entity. In an example, the bottleneck entity may be an entity which is in possession of at least one unit of the product. In another example, when multiple entities are in possession of at least one unit of the product, the bottleneck entity may be considered as one of the multiple entities which has highest possibility of affecting recovery of the plurality of units. For example, if the first primary wholesaler, the second secondary wholesaler immediately downstream the first primary wholesaler, and four retailers immediately downstream the second secondary wholesaler are in possession of at least one unit of the product, the first primary wholesaler, having 3,000 units of the particular medicine, may be considered as the bottleneck entity as it may be highly likely that either the first primary wholesaler may be unaware about the product recall action and may not have informed the second secondary wholesaler about the product recall action or the first primary wholesaler may have intentionally not informed the second secondary wholesaler about the product recall action. In turn, the second secondary wholesaler may not have informed the four retailers about the product recall action. Thus, the production recovery data and the distribution data may be processed to identify the first primary wholesaler as the bottleneck entity. By processing the distribution data and the product recovery data, the bottleneck entity may be effectively identified even in a complex distribution chain.

At block 408, an optimal communication strategy for communicating with the bottleneck entity may then be generated. The optimal communication strategy may be generated for transmission to the user to enable recovery of the plurality of units of the product by the organization. The optimal communication strategy may define a communication plan specifically tailored and customized for communicating with the bottleneck entity, directly or indirectly, such that one or more units of the product that are in possession of the bottleneck entity may be recovered quickly and efficiently. For example, an optimal communication strategy, specifically tailored for communicating with the first primary wholesaler, may be generated. In an example, the optimal communication strategy may be generated based on various factors such as characteristics, such as preferred communication mode, location, and position in the distribution chain, associated with the bottleneck entity, context of the product recall action, and responsiveness of the bottleneck entity to historical recall communications.

In an example, the optimal communication strategy may indicate one or more optimal communication modes to be used for communicating with the bottleneck entity. For example, a first optimal communication strategy corresponding to a first bottleneck entity may indicate that electronic mail (email) is an optimal communication mode for communicating with the first bottleneck entity. Further, a second optimal communication strategy corresponding to a second bottleneck entity may indicate that physical mail, short message service (SMS), and a phone call are optimal communication modes for communicating with the second bottleneck entity.

In an example, the optimal communication strategy may indicate an optimal re-attempt frequency corresponding to each of the one or more optimal communication modes. For example, the first optimal communication strategy may indicate that in case any unit pending at the first bottleneck entity is not recovered, re-attempting and sending the email three times may be useful for recovering the pending unit from the first bottleneck entity. Further, the second optimal communication strategy may indicate that in case any unit pending at the second bottleneck entity is not recovered, re-attempting and sending the physical email two times, the SMS three times, and the phone call five times may be useful for recovering the pending unit from the second bottleneck entity.

In addition, or alternatively, the optimal communication strategy may indicate a suggestion related to use of a third-party for communicating with the bottleneck entity. For example, the first optimal communication strategy may indicate that a particular third-party may be used for effectively recovering the pending unit from the first bottleneck entity, instead of communicating with the first bottleneck entity directly. Further, the second optimal communication strategy may indicate that another third-party may be used for effectively recovering the pending unit from the second bottleneck entity, instead of communicating with the second bottleneck entity directly.

In an example, the optimal communication strategy may be generated taking into account confidentiality and anonymity agreements between the one or more entities and one or more third-parties managing the external database, say the databases 202, which tracks distribution chains of products associated with the organization and stores data, i.e., the distribution data, describing movement of various units of the products in the distribution chains. Thus, while generating the optimal communication strategy, permitted communication channels according to the confidentiality and anonymity agreements associated with the bottleneck entity and various entities downstream to the bottleneck entity in the distribution chain may be utilized. For example, if a confidentiality and anonymity agreement associated with the bottleneck entity indicates the bottleneck entity is not to be communicated using any personal information, the optimal communication strategy for communicating with the bottleneck entity may include broadcasting about the product recall action through general communication modes, such as press releases, television advertisements, and social media announcements. Thus, communicating with the bottleneck entity using the optimal communication strategy may increase overall communication effectiveness and recall effectiveness for recalling and recovering the product.

FIG. 5 illustrates the method 500 for managing product recall effectiveness, according to another example.

At block 502, a bottleneck identification request may be received. The bottleneck identification request may be received in relation to a product recall action initiated by an organization to recall a plurality of units of a product. The product recall action may be initiated by the organization upon identifying the product to be defective, potentially harmful, or non-compliant with regulatory standards. In an example, the product recall action may include a recall decision taken by the organization after conducting investigations for assessing the quality of the product. In another example, the product recall action may include an action taken by the organization to issue a recall notice to all entities that are known to the organization and are likely to be affected by the recall decision. The recall notice may include recall-related information, such as the nature of the defect or issue in the product, potential risks associated with the product, and instructions for returning or disposing of the product. In an example, the bottleneck identification request may be triggered by a user associated with the organization to manage recall effectiveness for the product. For example, the user may be a recall manager, associated with a pharmaceutical company, responsible for managing recovery of various units of a particular medicine, such as a blood pressure medication, recalled due to a particular quality concern. The user may interact with a user interface of a software application or a web-based service managed by a system, say the system 100, to issue the bottleneck identification request by selecting a particular option on the user interface. The user may interact with the user interface through any electronic device, such as a desktop computer, a laptop, a tablet, a smartphone, and a wearable device. In another example, the bottleneck identification request may be automatically triggered once a pre-defined time interval has passed after initiation of the product recall action by the organization. For example, the bottleneck identification request may be automatically triggered once ten days have passed after initiation of the product recall action to identify bottlenecks affecting recovery of the plurality of units of the product by the organization.

At block 504, distribution data describing movement of each of the plurality of units among one or more entities may be obtained. For example, the distribution data, may describe the movement of the blood pressure medication through various wholesalers, pharmacies, and hospitals. The one or more entities may be involved in procurement and distribution of at least one of the plurality of units in a distribution chain of the product. For example, a first primary wholesaler may have procured 10,000 units of the particular medicine and a second primary wholesaler may have procured 20,000 units of the particular medicine from the pharmaceutical company. At a particular time at which the distribution data is obtained, the first primary wholesaler may be in possession of 3,000 units of the particular medicine and may have already distributed 7,000 units of the particular medicine, out of which 4,000 units may have been procured by a first secondary wholesaler and 2,000 units may have been procured by a second secondary wholesaler. At the particular time, the second primary wholesaler may not be in possession of any unit of the particular medicine. The second primary wholesaler may have returned 5,000 units of the particular medicine to the pharmaceutical company after initiation of the product recall action and may have already distributed 15,000 units of the particular medicine, out of which 5,000 units may have been procured by a third secondary wholesaler, 3,000 units may have been procured by a fourth secondary wholesaler, and 7,000 units may have been procured by a fifth secondary wholesaler. The first secondary wholesaler, the second secondary wholesaler, the third secondary wholesaler, the fourth secondary wholesaler, and the fifth secondary wholesaler may hereinafter be collectively referred to as secondary wholesalers. Each of the secondary wholesalers may be individually referred to as a secondary wholesaler. Similar to the first primary wholesaler and the second primary wholesaler, the secondary wholesalers may be in possession of one or more procured units of the particular medicine at the particular time. In addition, or alternatively, one or more of the secondary wholesalers may have returned one or more procured units of the particular medicine directly or indirectly to the pharmaceutical company. In addition, or alternatively, the secondary wholesalers may have distributed procured units of the particular medicine to various retailers. Similarly, the various retailers may or may not be in possession of one or more procured units of the particular medicine at the particular time and may or may not have returned one or more procured units of the particular medicine to the pharmaceutical company. In addition, or alternatively, the various retailers may have distributed one or more procured units of the particular medicine to various end consumers, such as patients. The end consumers may have consumed, may be in possession of, and/or may have returned one or more procured units of the particular medicine.

In an example, the distribution data may be electronic product code information services (EPCIS) data describing “what”, “when”, “where”, “why”, and “how” of the plurality of units of the product as the plurality of units move through the distribution chain among the one or more entities. Thus, the distribution data may include a unique unit identifier uniquely representing a particular unit of the product, a unique product identifier uniquely representing the product, information about the whereabouts of the plurality of units including location and timestamps of at least one of procurement and distribution of any of the plurality of units by each of the one or more entities, and details, such as name and location, associated with each of the one or more entities. In an example, the distribution data may be obtained from an external database that tracks distribution chains of products associated with the organization and stores data describing movement of various units of the products in the distribution chains. In another example, the distribution data may be generated and pre-stored in a memory, say the memory 212, by the system 100 and may be obtained from the memory.

At block 506, the distribution data may be analyzed to ascertain whether a particular entity, of the one or more entities, is in possession of at least one unit of the product. In an example, the distribution data and/or product recovery data may be analyzed to ascertain whether any entity of the one or more entities is in possession of at least one unit, from the one or more units, of the product. The product recovery data may indicate details of one or more units of the product pending to be recovered from the plurality of units. Upon ascertaining that none of the one or more entities is in possession of at least one unit of the product, (‘No’ path from block 506), a successful recall notification may be generated, at block 508. The successful recall notification may indicate successful recovery of the plurality of units of the product by the organization. In an example, the successful recall notification may be transmitted to the user to inform the user about successful recovery of the plurality of units of the product.

Upon ascertaining a particular entity, of the one or more entities, to be in possession of at least one unit of the product, (‘Yes’ path from block 506), the particular entity may be determined to be one of one or more probable bottleneck entities affecting the recovery of the plurality of units, at block 510. For example, if the first primary wholesaler, the second secondary wholesaler immediately downstream to the first primary wholesaler, and four retailers immediately downstream to the second secondary wholesaler possess at least one unit of the product, each of the first primary wholesaler, the second secondary wholesaler, and the four retailers may be determined to be probable bottleneck entities. If the one or more probable bottleneck entities include a single entity, the bottleneck identification engine 106 may designate the single entity as a bottleneck entity. The bottleneck entity may be an entity affecting recovery of the plurality of units of the product by the organization. In an example, the bottleneck entity may be an entity which is in possession of at least one unit of the product.

In another example, when the one or more probable bottleneck entities include multiple entities, at block 512, a specific entity, from the one or more probable bottleneck entities, having a highest precedence in the distribution chain amongst the one or more probable bottleneck entities may be determined. For example, since the first primary wholesaler has a highest precedence amongst the first primary wholesaler, the second secondary wholesaler, and the four retailers being at a top-most position in the distribution chain, the first primary wholesaler may be determined as the specific entity.

At block 514, the specific entity may be designated as the bottleneck entity. For example, the first primary wholesaler may be designated as the bottleneck entity. Thus, the bottleneck entity may be considered as one of the multiple entities which has highest possibility of affecting recovery of the plurality of units. For example, the first primary wholesaler, having 3,000 units of the particular medicine, may be considered as the bottleneck entity as it may be highly likely that either the first primary wholesaler may be unaware about the product recall action and may not have informed the second secondary wholesaler about the product recall action or the first primary wholesaler may have intentionally not informed the second secondary wholesaler about the product recall action. In turn, the second secondary wholesaler may not have informed the four retailers about the product recall action. Thus, the distribution data and/or the product recovery data may be processed to identify the first primary wholesaler as the bottleneck entity. Therefore, by processing the distribution data, the bottleneck entity may be effectively identified even in a complex distribution chain.

At block 516, an optimal communication strategy corresponding to each of the one or more probable bottleneck entities in addition to the bottleneck entity may be generated. The optimal communication strategy may be generated for transmission to the user to enable recovery of plurality of units of the product by the organization.

The optimal communication strategy may define a communication plan specifically tailored and customized for communicating with the one or more probable bottleneck entities, directly or indirectly, in addition to the bottleneck entity such that various units of the product that are in possession of the bottleneck entity may be recovered quickly and efficiently. In an example, the optimal communication strategy corresponding to each of the one or more probable bottleneck entities in addition to the bottleneck entity may be generated so that a greater number of units of the product may be recovered. For example, optimal communication strategies may be generated specifically tailored for communicating with the first primary wholesaler, the second secondary wholesaler, and the four retailers. In an example, the optimal communication strategy may be generated based on various factors such as characteristics, such as preferred communication mode, location, and position in the distribution chain, associated with the bottleneck entity, context of the product recall action, and responsiveness of the bottleneck entity to historical recall communications. In an example, the optimal communication strategy may be generated taking into account confidentiality and anonymity agreements between the one or more entities and one or more third-parties managing the databases 202 which tracks distribution chains of products associated with the organization and stores data, i.e., the distribution data, describing movement of various units of the products in the distribution chains. Thus, while generating the optimal communication strategy, the recommendation generation engine 108 may utilize permitted communication channels according to the confidentiality and anonymity agreements associated with the bottleneck entity and various entities downstream to the bottleneck entity in the distribution chain. For example, if a confidentiality and anonymity agreement associated with the bottleneck entity indicates the bottleneck entity is not to be communicated using any personal information, the optimal communication strategy for communicating with the bottleneck entity may include broadcasting the recall notice through general communication modes, such as press releases, television advertisements, and social media announcements. Thus, communicating with the bottleneck entity using the optimal communication strategy may increase overall communication effectiveness and recall effectiveness for recalling and recovering the product.

FIG. 6 illustrates the method 600 for managing product recall effectiveness, according to another example.

At block 602, a particular location to which a bottleneck entity belongs may be identified. The bottleneck entity may be an entity affecting recovery of the plurality of units of the product by the organization. For example, a first primary wholesaler, designated as the bottleneck entity, may be identified to be based in Germany. In an example, the particular location may be identified based on details of the bottleneck entity included in distribution data, say the distribution data obtained at block 504 of the method 500.

At block 604, real-time information about the particular location may be obtained. The real-time information may include current weather conditions and local events, such as local festival celebration and a catastrophic event, associated with the particular location. In an example, the real-time information may be obtained from user. In another example, the real-time information may be obtained from external sources, for example, by conducting a web-based search about the particular location over the internet. In yet another example, the real-time information may be pre-stored in a memory, say the memory 212, and may be obtained from the memory.

At block 606, pre-defined information associated with the particular location may be obtained. The pre-defined information may include local regulations, cultural considerations, historical recall performance, and typical business practices specific to the particular location. In an example, the pre-defined information may be obtained from a user associated with an organization monitoring the product recall effectiveness. In another example, the pre-defined information may be obtained from external sources, for example, by conducting a web-based search about the particular location over the internet. In yet another example, the pre-defined information may be pre-stored in the memory and may be obtained from the memory.

At block 608, an optimal communication strategy for communicating with the bottleneck entity may be generated. In an example, the real-time information and the pre-defined information may be analyzed to generate the optimal communication strategy. For example, if the real-time information indicates that the particular location, at which at least one unit of the product is pending, is in a war situation or the particular location is dealing with after-effects of a catastrophic event, the optimal communication strategy may indicate that an optimal communication mode may be a news article or other broadcasting means instead of using SMS and phone calls. Further, if the pre-defined information indicates third-parties at the particular location, say Germany, do not prefer to work in an ongoing month, the optimal communication strategy may indicate that using a third party from another location may be more efficient for communicating with the bottleneck entity during the ongoing month rather than using a third party belonging to the particular location. Additionally, or alternately, news article, SMS, or other broadcasting means may be used for communicating with the bottleneck entity during the ongoing month. Thus, both the real-time information and the pre-defined information about the particular location may be utilized for generating the optimal communication strategy.

FIG. 7 illustrates the method 700 for managing product recall effectiveness, according to another example.

At block 702, information about a bottleneck entity determined as a bottleneck, for example, at block 406 of the method 400 or at block 514 of the method 500, may be obtained. The bottleneck entity may be an entity affecting recovery of a plurality of units of a product by an organization.

At block 704, it may be ascertained whether the bottleneck entity was identified as a bottleneck during any historical product recall performed by the organization. For ascertaining whether the bottleneck entity was identified as a bottleneck during any historical product recall, historical recall data may be obtained and analyzed. The historical recall data may describe historical product recalls conducted by the organization, encompassing details such as the effectiveness of the historical product recalls, response times of various entities in distribution chains of recalled products associated with the historical product recalls, communication strategies used to communicate with the various entities during the historical product recalls, and the performance of the various entities in returning the recalled products. The historical recall data may include unique identifiers of specific entities identified as bottleneck during the historical product recalls. Thus, a unique identifier of the bottleneck entity may be compared with the unique identifiers of the specific entities to ascertain whether the bottleneck entity was identified as a bottleneck during any of the historical product recalls. In an example, the historical recall data may be obtained from an external database managing records of the historical product recalls conducted by the organization. In another example, the historical recall data may be pre-stored in a memory, say the memory 212, of the system 100 and may be obtained from the memory.

Upon ascertaining that the bottleneck entity was not identified as a bottleneck during any historical product recall, (‘No’ path from block 704), an optimal communication strategy may be generated for communicating with the bottleneck entity, at block 706. In other words, the optimal communication strategy may be generated without reference to any historical product recalls, as generated at block 408 of the method 400, block 516 of the method 500, and block 608 of the method 600.

Upon ascertaining the bottleneck entity to have been identified as a bottleneck during a historical product recall, (‘Yes’ path from block 704), historical communication data corresponding to the historical product recall may be obtained, at block 708. The historical communication data may describe a historical communication strategy implemented corresponding to the historical product recall for communicating with the bottleneck entity. The historical communication strategy may indicate at least one of communication modes used for communicating with the bottleneck entity during the historical product recall, number of re-attempts made corresponding to each of the communication modes, details of a specific third-party utilized for communicating with the bottleneck entity during the historical product recall. In an example, the historical communication data may be obtained from the external database managing records of the historical product recalls conducted by the organization. In another example, the historical communication data may be pre-stored in the memory and may be obtained from the memory.

At block 710, a current communication strategy, initially utilized to communicate with the bottleneck entity when the product is recalled by the organization, may be obtained. The current communication strategy may indicate at least one of current communication modes used for communicating with the bottleneck entity, number of re-attempts made corresponding to each of the current communication modes, details of a specific third-party utilized for communicating with the bottleneck entity. In an example, the current communication strategy may be obtained from a user associated with the organization or any third-party. In another example, the current communication strategy may be pre-stored in the memory and may be obtained from the memory.

At block 712, the current communication strategy and the historical communication strategy may be analyzed to generate an optimal communication strategy for communicating with the bottleneck entity. For example, the historical communication strategy may indicate that the bottleneck entity did not return pending product units when the bottleneck entity was communicated through an email as a communication mode, but the bottleneck entity returned the pending product units when a phone call was used as a communication mode. Thus, if the current communication strategy does not include a phone call as a communication mode, the optimal communication strategy may be generated so as to indicate a phone call as an optimal communication mode. Similarly, the optimal re-attempt frequency and the suggestion related to use of a third-party may be decided based on the analysis of the current communication strategy and the historical communication strategy.

FIG. 8 illustrates the method 800 for managing product recall effectiveness, according to yet another example.

At block 802, distribution data associated with a product may be obtained. The distribution data may describe movement of each of a plurality of units of the product, manufactured by an organization, among one or more entities involved in procurement and distribution of at least one of the plurality of units in a distribution chain of the product. In an example, the distribution data may be electronic product code information services (EPCIS) data describing “what”, “when”, “where”, “why”, and “how” of the plurality of units of the product as the plurality of units move through the distribution chain among the one or more entities. Thus, the distribution data may include a unique unit identifier uniquely representing a particular unit of the product, a unique product identifier uniquely representing the product, information about the whereabouts of the plurality of units including location and timestamps of at least one of procurement and distribution of any of the plurality of units by each of the one or more entities, and details, such as name and location, associated with each of the one or more entities. In an example, the distribution data may be obtained from an external database that tracks distribution chains of products associated with the organization and stores data describing movement of various units of the products in the distribution chains. In another example, the distribution data may be pre-stored in a memory, say the memory 212, of the system 100 and may be obtained from the memory.

At block 804, the distribution data may be processed to generate a distribution path associated with the product. The distribution path may be a visual representation of the movement of each of the plurality of units among the one or more entities. For example, the distribution path may be a tree-like structure, where a root node, i.e., a topmost node, may be a manufacturer of the product and child nodes, downstream to the root node, may be the one or more entities. The tree-like structure may represent the movement of each of the plurality of units from the root node to the one or more entities and the movement of each of the plurality of units among the one or more entities.

At block 806, the distribution path may be rendered on a user interface. In an example, the distribution path may be rendered on a user interface as a visually engaging tree-like structure, where the root node at the top may represent the manufacturer, and subsequent child nodes may represent various entities such as distributors, retailers, and consumers. The movement of the plurality of units from the manufacturer to the one or more entities and among the one or more entities may be represented through lines and arrows. In an example, the user interface may be an interactive interface, allowing a user associated with the organization to click or hover over nodes to reveal additional information, such as number of units of the product procured or distributed by an entity associated with a particular node with relevant timestamps of procurement and distribution. In an example, the user interface may be accessed by the user through a user device, say the user device 204.

FIG. 9 illustrates the method 900 for managing product recall effectiveness, according to another example.

At block 902, entity data describing each of one or more entities may be obtained. The one or more entities may be involved in procurement and distribution of at least one of a plurality of units of a product, manufactured by an organization, in a distribution chain of the product. The entity data may include details such as name and location of each of the one or more entities. In an example, the entity data may be included in distribution data, say the distribution data obtained at block 802 of the method 800, and may thus be obtained directly from one or more databases, say the databases 202. In another example, the entity data may be pre-stored in a memory, say the memory 212, of the system after retrieving the entity data from the one or more databases and may be obtained from the memory.

At block 904, one or more anonymized entities may be generated. In an example, each of the one or more entities may be anonymized based on the entity data to generate the one or more anonymized entities. For example, if a particular entity having name “ABC” is based in Germany, an anonymized version of the particular entity may be “Germany-based entity”.

At block 906, the distribution data and the one or more anonymized entities may be processed to generate an anonymized distribution path visually representing the movement of each of the plurality of units among the one or more anonymized entities. For example, the anonymized distribution path may be a tree-like structure, where a root node, i.e., a topmost node, may be a manufacturer of the product and child nodes, downstream to the root node, may be the one or more anonymized entities. The tree-like structure may represent the movement of each of the plurality of units from the root node to the one or more anonymized entities and the movement of each of the plurality of units among the one or more anonymized entities. Thus, instead of using real-identities of the one or more entities, anonymized identities of the one or more entities may be used in the anonymized distribution path.

At block 908, the anonymized distribution path may be rendered on a user interface. In an example, the user interface may be accessed by the user through a user device, say the user device 204. Thus, instead of revealing the real-identities of the one or more entities to the user, the user may be presented with the anonymized distribution path. For example, entity data may indicate a geographic location of each of the one or more entities and the anonymized distribution path may indicate how the plurality of units moved between entities at different geographic locations without revealing the real identities of the one or more entities. The present subject matter thus offers significant advantages in managing product recalls, specifically improving effectiveness of product recalls, across complex distribution chains.

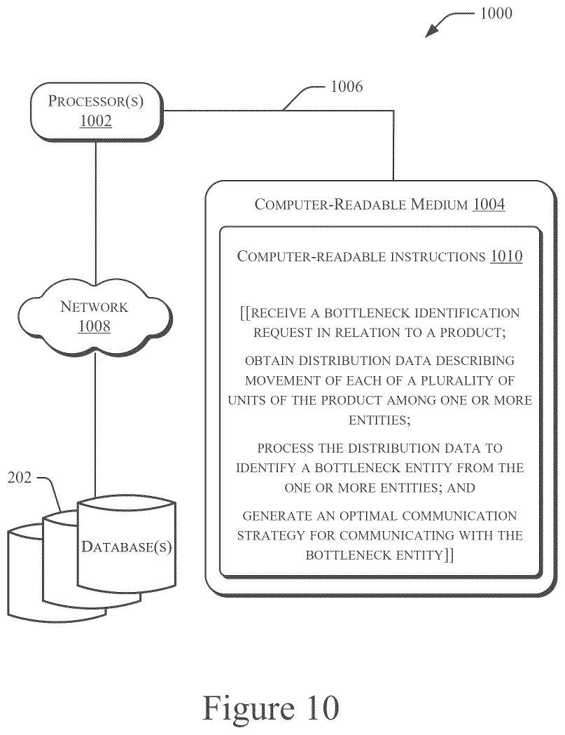

FIG. 10 illustrates a computing environment 1000 implementing a non-transitory computer-readable medium for managing product recall effectiveness, according to an example. In an example, the computing environment 1000 includes processor(s) 1002 communicatively coupled to a non-transitory computer-readable medium 1004 through a communication link 1006. In one example, the communication link 1006 may be similar to the communication network 206, as described in conjunction with the preceding figures. In an example implementation, the computing environment 1000 may be for example, the computing environment 200. In an example, the processor(s) 1002 may have one or more processing resources for fetching and executing computer-readable instructions from the non-transitory computer-readable medium 1004. The processor(s) 1002 and the non-transitory computer-readable medium 1004 may be implemented, for example, in the system 100 (as has been described in conjunction with the preceding figures).

The non-transitory computer-readable medium 1004 may be, for example, an internal memory device or an external memory device. In an example implementation, the communication link 1006 may be a network communication link. The processor(s) 1002 and the non-transitory computer-readable medium 1004 may also be communicatively coupled to the database(s) 202 over a network 1008. The network 1008 may be similar to the communication network 206 described in conjunction with FIG. 2.

In an example implementation, the non-transitory computer-readable medium 1004 may include a set of computer-readable instructions 1010 which may be accessed by the processor(s) 1002 through the communication link 1006. Referring to FIG. 10, in an example, the non-transitory computer-readable medium 1004 may include instructions 1010 that may cause the processor(s) 1002 to receive a bottleneck identification request in relation to a product recall action initiated by an organization to recall a plurality of units of a product. The product recall action may be initiated by the organization upon identifying the product to be defective, potentially harmful, or non-compliant with regulatory standards. In an example, the product recall action may include a recall decision taken by the organization after conducting investigations for assessing the quality of the product. In another example, the product recall action may include an action taken by the organization to issue a recall notice to all entities that are known to the organization and are likely to be affected by the recall decision. The recall notice may include recall-related information, such as the nature of the defect or issue in the product, potential risks associated with the product, and instructions for returning or disposing of the product. In an example, the bottleneck identification request may be triggered by a user associated with the organization to manage recall effectiveness for the product. For example, the user may be a recall manager, associated with a pharmaceutical company, responsible for managing recovery of various units of a particular medicine, such as a blood pressure medication, recalled due to a particular quality concern. The user may interact with a user interface of a software application or a web-based services, to issue the bottleneck identification request by selecting a particular option on the user interface. In another example, the bottleneck identification request may be automatically triggered once a pre-defined time interval has passed after initiation of the product recall action by the organization. For example, the bottleneck identification request may be automatically triggered once ten days have passed after initiation of the product recall action to identify bottlenecks affecting recovery of the plurality of units of the product by the organization.

In an example, the instructions 1010 may cause the processor(s) 1002 to obtain distribution data describing movement of each of a plurality of units of the product, among one or more entities. For example, the distribution data may describe the movement of the blood pressure medication through various wholesalers, pharmacies, and hospitals. The one or more entities may be involved in procurement and distribution of at least one of the plurality of units in a distribution chain of the product. For example, a first primary wholesaler may have procured 10,000 units of the particular medicine and a second primary wholesaler may have procured 20,000 units of the particular medicine from the pharmaceutical company. At a particular time at which the distribution data is obtained, the first primary wholesaler may be in possession of 3,000 units of the particular medicine and may have already distributed 7,000 units of the particular medicine, out of which 4,000 units may have been procured by a first secondary wholesaler and 2,000 units may have been procured by a second secondary wholesaler. At the particular time, the second primary wholesaler may not be in possession of any unit of the particular medicine. The second primary wholesaler may have returned 5,000 units of the particular medicine to the pharmaceutical company after initiation of the product recall action and may have already distributed 15,000 units of the particular medicine, out of which 5,000 units may have been procured by a third secondary wholesaler, 3,000 units may have been procured by a fourth secondary wholesaler, and 7,000 units may have been procured by a fifth secondary wholesaler. The first secondary wholesaler, the second secondary wholesaler, the third secondary wholesaler, the fourth secondary wholesaler, and the fifth secondary wholesaler may hereinafter be collectively referred to as secondary wholesalers. Each of the secondary wholesalers may be individually referred to as a secondary wholesaler. Similar to the first primary wholesaler and the second primary wholesaler, the secondary wholesalers may be in possession of one or more procured units of the particular medicine at the particular time. In addition, or alternatively, one or more of the secondary wholesalers may have returned one or more procured units of the particular medicine directly or indirectly to the pharmaceutical company. In addition, or alternatively, the secondary wholesalers may have distributed procured units of the particular medicine to various retailers. Similarly, the various retailers may or may not be in possession of one or more procured units of the particular medicine at the particular time and may or may not have returned one or more procured units of the particular medicine to the pharmaceutical company. In addition, or alternatively, the various retailers may have distributed one or more procured units of the particular medicine to various end consumers, such as patients. The end consumers may have consumed, may be in possession of, and/or may have returned one or more procured units of the particular medicine.

In an example, the distribution data may be electronic product code information services (EPCIS) data describing “what”, “when”, “where”, “why”, and “how” of the plurality of units of the product as the plurality of units move through the distribution chain among the one or more entities. Thus, the distribution data may include a unique unit identifier uniquely representing a particular unit of the product, a unique product identifier uniquely representing the product, information about the whereabouts of the plurality of units including location and timestamps of at least one of procurement and distribution of any of the plurality of units by each of the one or more entities, and details, such as name and location, associated with each of the one or more entities. In an example, the distribution data may be obtained from an external database, say the databases 202, that tracks distribution chains of products associated with the organization and stores data describing movement of various units of the products in the distribution chains. In another example, the distribution data may be pre-stored in a memory, say the memory 212, after retrieving the distribution data from the external database and may be obtained from the memory.

In addition, or alternatively, the instructions 1010 may cause the processor(s) 1002 to obtain product recovery data associated with the product recall action. The product recovery data may indicate details, such as unique identifiers, of one or more units of the product pending to be recovered from the plurality of units. The organization may maintain a record of details of the plurality of units that were distributed and details of particular units that have been recovered by the organization. The details of the plurality of units and the details of the particular units may be compared to identify the one or more units of the product that are pending to be recovered and generate the product recovery data. For example, details of 30,000 units of the particular medicine distributed by the pharmaceutical company may be compared with details of 10,000 units of the particular medicine recovered by the organization to generate the product recovery data including details of 20,000 units of the product pending to be recovered by the organization. In an example, the product recovery data may be obtained from an external database managing details of the one or more units of the product pending to be recovered by the organization. In another example, the product recovery data may be generated and pre-stored in the memory and may be obtained from the memory.

The instructions 1010 may then cause the processor(s) 1002 to process the distribution data to identify a bottleneck entity from the one or more entities. In an example, the instructions 1010 may cause the processor(s) 1002 to process the product recovery data in addition to the distribution data to identify the bottleneck entity. The bottleneck entity may be an entity affecting recovery of the plurality of units of the product by the organization. In an example, for identifying the bottleneck entity, the distribution data and/or the product recovery data may be processed to identify which of the one or more entities satisfy one or more pre-determined conditions for qualifying as the bottleneck entity. Examples of the one or more pre-determined conditions for qualifying as the bottleneck entity may include, but are not limited to, a threshold number of units of the product that should be in possession of an entity, and a potential downstream impact of an entity based on a position of the entity in the distribution chain. For example, a primary wholesaler which has a significant downstream impact for having multiple secondary wholesalers, retailers, and end consumers downstream in the distribution chain, and which is determined to be in possession of at least 100 units of the product may be considered as the bottleneck entity.

For identifying the bottleneck entity, the instructions 1010 may cause the processor(s) 1002 to ascertain whether any entity of the one or more entities is in possession of at least one unit, from the plurality of units of the product. In an example, the distribution data and/or the product recovery data may be analyzed to ascertain whether any entity of the one or more entities is in possession of the at least one unit. In case none of the one or more entities are identified to be in possession of at least one unit of the product, a successful recall notification indicating successful recovery of the plurality of units of the product by the organization may be generated.

In one example, the instructions 1010 may cause the processor(s) 1002 to designate each of the one or more entities ascertained to be in possession of at least one unit of the product as the bottleneck entity.

In another example, upon ascertaining a particular entity, of the one or more entities, to be in possession of at least one unit of the product, the instructions 1010 may cause the processor(s) 1002 to determine the particular entity to be one of one or more probable bottleneck entities affecting the recovery of the plurality of units. For example, if the first primary wholesaler, the second secondary wholesaler immediately downstream to the first primary wholesaler, and four retailers immediately downstream to the second secondary wholesaler possess at least one unit of the product, each of the first primary wholesaler, the second secondary wholesaler, and the four retailers may be determined to be probable bottleneck entities. If the one or more probable bottleneck entities include a single entity, the instructions 1010 may cause the processor(s) 1002 to designate the single entity as the bottleneck entity.

However, when the one or more probable bottleneck entities include multiple entities, the instructions 1010 may cause the processor(s) 1002 to determine a specific entity, from the one or more probable bottleneck entities, having a highest precedence in the distribution chain amongst the one or more probable bottleneck entities. The instructions 1010 may cause the processor(s) 1002 to designate the specific entity as the bottleneck entity. For example, since the first primary wholesaler has a highest precedence amongst the first primary wholesaler, the second secondary wholesaler, and the four retailers being at a top-most position in the distribution chain, the first primary wholesaler may be selected as the bottleneck entity. Thus, the bottleneck entity may be considered as one of the multiple entities which has the highest possibility of affecting recovery of the plurality of units. For example, the first primary wholesaler, having 3,000 units of the particular medicine, may be considered as the bottleneck entity as it may be highly likely that either the first primary wholesaler may be unaware about the product recall action and may not have informed the second secondary wholesaler about the product recall action or the first primary wholesaler may have intentionally not informed the second secondary wholesaler about the product recall action. In turn, the second secondary wholesaler may not have informed the four retailers about the product recall action. Therefore, by processing the distribution data and the product recovery data, the bottleneck entity may be effectively identified even in a complex distribution chain.

Once the bottleneck identity is identified, the instructions 1010 may cause the processor(s) 1002 to generate an optimal communication strategy for communicating with the bottleneck entity. The optimal communication strategy may be generated for transmission to the user to enable recovery of the plurality of units of the product by the organization.

The optimal communication strategy may define a communication plan specifically tailored and customized for communicating with the bottleneck entity, directly or indirectly, such that various units of the product that are in possession of the bottleneck entity may be recovered quickly and efficiently. For example, the instructions 1010 may cause the processor(s) 1002 to generate an optimal communication strategy specifically tailored for communicating with the first primary wholesaler. In an example, the optimal communication strategy may be generated based on various factors, such as characteristics, such as preferred communication mode, location, and position in the distribution chain, associated with the bottleneck entity, context of the product recall action, and responsiveness of the bottleneck entity to historical recall communications. Thus, communicating with the bottleneck entity using the optimal communication strategy may increase overall communication effectiveness and recall effectiveness for recalling and recovering the product.

In an example, the optimal communication strategy may indicate one or more optimal communication modes to be used for communicating with the bottleneck entity. For example, a first optimal communication strategy corresponding to a first bottleneck entity may indicate that electronic mail (email) is an optimal communication mode for communicating with the first bottleneck entity. Further, a second optimal communication strategy corresponding to a second bottleneck entity may indicate that physical mail, short message service (SMS), and a phone call are optimal communication modes for communicating with the second bottleneck entity.

In an example, the optimal communication strategy may indicate an optimal re-attempt frequency corresponding to each of the one or more optimal communication modes. For example, the first optimal communication strategy may indicate that in case any unit pending at the first bottleneck entity is not recovered, re-attempting and sending the email three times may be useful for recovering the pending unit from the first bottleneck entity. Further, the second optimal communication strategy may indicate that in case any unit pending at the second bottleneck entity is not recovered, re-attempting and sending the physical email two times, the SMS three times, and the phone call five times may be useful for recovering the pending unit from the second bottleneck entity.

In addition, or alternatively, the optimal communication strategy may indicate a suggestion related to use of a third-party for communicating with the bottleneck entity. For example, the first optimal communication strategy may indicate that a particular third-party may be used for effectively recovering the pending unit from the first bottleneck entity, instead of communicating with the first bottleneck entity directly. Further, the second optimal communication strategy may indicate that another third-party may be used for effectively recovering the pending unit from the second bottleneck entity, instead of communicating with the second bottleneck entity directly.

In an example, the instructions 1010 may cause the processor(s) 1002 to generate an optimal communication strategy corresponding to each of the one or more probable bottleneck entities in addition to the bottleneck entity so that a greater number of units of the product may be recovered.

In an example, the optimal communication strategy may be generated taking into account confidentiality and anonymity agreements between the one or more entities and one or more third-parties managing the external database, say the databases 202, which tracks distribution chains of products associated with the organization and stores data, i.e., the distribution data, describing movement of various units of the products in the distribution chains. Thus, while generating the optimal communication strategy, the instructions 1010 may cause the processor(s) 1002 to utilize permitted communication channels according to the confidentiality and anonymity agreements associated with the bottleneck entity and various entities downstream to the bottleneck entity in the distribution chain. For example, if a confidentiality and anonymity agreement associated with the bottleneck entity indicates the bottleneck entity is not to be communicated using any personal information, the optimal communication strategy for communicating with the bottleneck entity may include broadcasting the recall notice through general communication modes, such as press releases, television advertisements, and social media announcements.

In an example, the optimal communication strategy may be tailored based on a geographic location of the bottleneck entity. For tailoring the optimal communication strategy, the instructions 1010 may cause the processor(s) 1002 to identify a particular location to which the bottleneck entity belongs. For example, the first primary wholesaler, designated as the bottleneck entity, may be identified to be based in Germany. In an example, the particular location may be identified based on details of the bottleneck entity included in the distribution data.

Then, the instructions 1010 may cause the processor(s) 1002 to obtain real-time information about the particular location. The real-time information may include current weather conditions and local events, such as local festival celebration and a catastrophic event, associated with the particular location. In an example, the real-time information may be obtained from the user. In another example, the real-time information may be obtained from external sources, for example, by conducting a web-based search about the particular location over the internet. In yet another example, the real-time information may be pre-stored in the memory and may be obtained from the memory.

Further, the instructions 1010 may cause the processor(s) 1002 to obtain pre-defined information associated with the particular location. The pre-defined information may include local regulations, cultural considerations, historical recall performance, and typical business practices specific to the particular location. In an example, the pre-defined information may be obtained from the user. In another example, the pre-defined information may be obtained from external sources, for example, by conducting a web-based search about the particular location over the internet. In yet another example, the pre-defined information may be pre-stored in the memory and may be obtained from the memory.

The instructions 1010 may cause the processor(s) 1002 to analyze the real-time information and the pre-defined information to generate the optimal communication strategy. For example, if the real-time information indicates that the particular location, at which at least one unit of the product is pending, is in a war situation or the particular location is dealing with after-effects of a catastrophic event, the optimal communication strategy may indicate that an optimal communication mode may be a news article or other broadcasting means instead of using SMS and phone calls. Further, if the pre-defined information indicates third-parties at the particular location, say Germany, do not prefer to work in an ongoing month, the optimal communication strategy may indicate that using a third party from another location may be more efficient for communicating with the bottleneck entity during the ongoing month rather than using a third party belonging to the particular location. Additionally, or alternately, news article, SMS, or other broadcasting means may be used for communicating with the bottleneck entity during the ongoing month. Thus, both the real-time information and the pre-defined information about the particular location may be utilized for generating the optimal communication strategy.

In an example, the optimal communication strategy may be tailored based on historical behavior of the bottleneck entity. For tailoring the optimal communication strategy, the instructions 1010 may cause the processor(s) 1002 to ascertain whether the bottleneck entity was identified as a bottleneck during any historical product recall performed by the organization. For ascertaining whether the bottleneck entity was identified as a bottleneck during any historical product recall, the instructions 1010 may cause the processor(s) 1002 to obtain and analyze historical recall data describing the historical product recalls conducted by the organization. The historical recall data may include unique identifiers of specific entities identified as bottleneck during the historical product recalls. Thus, a unique identifier of the bottleneck entity may be compared with the unique identifiers of the specific entities to ascertain whether the bottleneck entity was identified as a bottleneck during any of the historical product recalls. In an example, the historical recall data may be obtained from an external database managing records of the historical product recalls conducted by the organization. In another example, the historical recall data may be pre-stored in the memory and may be obtained from the memory.

Upon ascertaining the bottleneck entity to have been identified as a bottleneck during a historical product recall, the instructions 1010 may cause the processor(s) 1002 to obtain historical communication data describing a historical communication strategy implemented corresponding to the historical product recall for communicating with the bottleneck entity. The historical communication strategy may indicate at least one of communication modes used for communicating with the bottleneck entity during the historical product recall, number of re-attempts made corresponding to each of the communication modes, details of a specific third-party utilized for communicating with the bottleneck entity during the historical product recall. In an example, the historical communication data may be obtained from the external database managing records of the historical product recalls conducted by the organization. In another example, the historical communication data may be pre-stored in the memory and may be obtained from the memory.

The instructions 1010 may further cause the processor(s) 1002 to obtain a current communication strategy initially utilized to communicate with the bottleneck entity when the product is recalled by the organization. The current communication strategy may indicate at least one of current communication modes used for communicating with the bottleneck entity, number of re-attempts made corresponding to each of the current communication modes, details of a specific third-party utilized for communicating with the bottleneck entity. In an example, the current communication strategy may be obtained from the user. In another example, the current communication strategy may be pre-stored in the memory and may be obtained from the memory.

The instructions 1010 may cause the processor(s) 1002 to analyze the current communication strategy and the historical communication strategy to generate the optimal communication strategy for communicating with the bottleneck entity. For example, the historical communication strategy may indicate that the bottleneck entity did not return pending product units when the bottleneck entity was communicated through an email as a communication mode, but the bottleneck entity returned the pending product units when a phone call was used as a communication mode. Thus, if the current communication strategy does not include a phone call as a communication mode, the optimal communication strategy may be generated so as to indicate a phone call as an optimal communication mode. Similarly, the optimal re-attempt frequency and the suggestion related to use of a third-party may be decided based on the analysis of the current communication strategy and the historical communication strategy.

In an example, the instructions 1010 may cause the processor(s) 1002 to process the distribution data to generate a distribution path associated with the product. The distribution path may be a visual representation of the movement of each of the plurality of units among the one or more entities. For example, the distribution path may be a tree-like structure, where a root node, i.e., a topmost node, may be a manufacturer of the product and child nodes, downstream to the root node, may be the one or more entities. The tree-like structure may represent the movement of each of the plurality of units from the root node to the one or more entities and the movement of each of the plurality of units among the one or more entities. The instructions 1010 may then cause the processor(s) 1002 to render the distribution path on a user interface. In an example, the user interface may be accessed by the user through a user device, say the the user device 204.

In another example, before rendering the distribution path, the instructions 1010 may cause the processor(s) 1002 to obtain entity data describing each of the one or more entities. The entity data may include details such as name and location of each of the one or more entities. In an example, the entity data may be included in the distribution data and may thus be obtained directly from the external database, say the databases 202. In another example, the entity data may be pre-stored in the memory after retrieving the entity data from the databases and may be obtained from the memory.

The instructions 1010 may cause the processor(s) 1002 to anonymize each of the one or more entities based on the entity data to generate one or more anonymized entities. For example, if a particular entity having name “ABC” is based in Germany, an anonymized version of the particular entity may be “Germany-based entity”.

The instructions 1010 may cause the processor(s) 1002 to process the distribution data and the one or more anonymized entities to generate an anonymized distribution path visually representing the movement of each of the plurality of units among the one or more anonymized entities. For example, the anonymized distribution path may be a tree-like structure, where a root node, i.e., a topmost node, may be a manufacturer of the product and child nodes, downstream to the root node, may be the one or more anonymized entities. The tree-like structure may represent the movement of each of the plurality of units from the root node to the one or more anonymized entities and the movement of each of the plurality of units among the one or more anonymized entities. Thus, instead of using real-identities of the one or more entities, anonymized identities of the one or more entities may be used in the anonymized distribution path.

The instructions 1010 may then cause the processor(s) 1002 to render the anonymized distribution path on a user interface. In an example, the user interface may be accessed by the user through a user device, say the user device 204. Thus, instead of revealing the real-identities of the one or more entities to the user, the user may be presented with the anonymized distribution path. For example, entity data may indicate a geographic location of each of the one or more entities and the anonymized distribution path may indicate how the plurality of units moved between entities at different geographic locations without revealing the real identities of the one or more entities. The present subject matter thus offers significant advantages in managing product recalls, specifically improving effectiveness of product recalls, across complex distribution chains.

Although examples for the present disclosure have been described in language specific to structural features and/or methods, it is to be understood that the appended claims are not necessarily limited to the specific features or methods described. Rather, the specific features and methods are disclosed and explained as examples of the present disclosure

We claim:

1. A system comprising:
a bottleneck identification engine to:
receive a bottleneck identification request in relation to a product recall action initiated by an organization to recall a plurality of units of a product;
obtain distribution data describing movement of each of the plurality of units among one or more entities involved in procurement and distribution of at least one of the plurality of units in a distribution chain of the product; and
process the distribution data to identify a bottleneck entity, from the one or more entities, affecting recovery of the plurality of units of the product by the organization; and
a recommendation generation engine to:
generate, for transmission to a user, an optimal communication strategy for communicating with the bottleneck entity to enable recovery of the plurality of units of the product by the organization.

2. The system of claim 1, wherein the bottleneck identification engine is to:
ascertain whether any entity of the one or more entities is in possession of at least one unit, from the plurality of units, of the product;
upon ascertaining a particular entity, of the one or more entities, to be in possession of at least one unit of the product, determine the particular entity to be one of one or more probable bottleneck entities affecting the recovery of the plurality of units;
determine a specific entity, from the one or more probable bottleneck entities, having a highest precedence in the distribution chain amongst the one or more probable bottleneck entities; and
designate the specific entity as the bottleneck entity.

3. The system of claim 2, wherein the recommendation generation engine is to:
generate, for transmission to the user, an optimal communication strategy corresponding to each of the one or more probable bottleneck entities in addition to the bottleneck entity.

4. The system of claim 1, wherein the optimal communication strategy indicates at least one of:
one or more optimal communication modes to be used for communicating with the bottleneck entity;
an optimal re-attempt frequency corresponding to each of the one or more optimal communication modes; and
a suggestion related to use of a third-party for communicating with the bottleneck entity.

5. The system of claim 1, wherein the recommendation generation engine is to:
identify a particular location to which the bottleneck entity belongs;
obtain real-time information about the particular location;
obtain pre-defined information associated with the particular location; and
analyze the real-time information and the pre-defined information to generate the optimal communication strategy.

6. The system of claim 1, wherein the system comprises:
a communication configuration engine to:
ascertain whether the bottleneck entity was identified as a bottleneck during any historical product recall performed by the organization;
upon ascertaining the bottleneck entity to have been identified as a bottleneck during a historical product recall, obtain historical communication data describing a historical communication strategy implemented corresponding to the historical product recall for communicating with the bottleneck entity;
obtain a current communication strategy initially utilized to communicate with the bottleneck entity when the product is recalled by the organization; and
analyze the current communication strategy and the historical communication strategy to generate the optimal communication strategy for communicating with the bottleneck entity.

7. The system of claim 1, wherein the system comprises a path rendering engine to:
process the distribution data to generate a distribution path associated with the product, wherein the distribution path is a visual representation of the movement of each of the plurality of units among the one or more entities; and
render the distribution path on a user interface.

8. The system of claim 1, wherein the system comprises a path rendering engine to:
obtain entity data describing each of the one or more entities;
anonymize each of the one or more entities based on the entity data to generate one or more anonymized entities;
process the distribution data and the one or more anonymized entities to generate an anonymized distribution path visually representing the movement of each of the plurality of units among the one or more anonymized entities; and
render the anonymized distribution path on a user interface.

9. A method comprising:
obtaining product recovery data associated with a product recall action initiated by an organization to recall a plurality of units of a product, the product recovery data indicating details of one or more units of the product pending to be recovered from the plurality of units;
obtaining distribution data describing movement of each of the plurality of units among one or more entities involved in procurement and distribution of at least one of the plurality of units in a distribution chain of the product;
processing the product recovery data and the distribution data to identify a bottleneck entity, from the one or more entities, affecting recovery of the one or more units of the product by the organization; and
generating, for transmission to a user, an optimal communication strategy for communicating with the bottleneck entity to enable recovery of the one or more units of the product by the organization.

10. The method of claim 9, wherein the method comprises:
analyzing the product recovery data and the distribution data to ascertain whether any entity of the one or more entities is in possession of at least one unit, from the one or more units, of the product;
upon ascertaining a particular entity, of the one or more entities, to be in possession of at least one unit of the product, determine the particular entity to be one of one or more probable bottleneck entities affecting the recovery of the one or more units;
determining a specific entity, from the one or more probable bottleneck entities, having a highest precedence in the distribution chain amongst the one or more probable bottleneck entities; and
designating the specific entity as the bottleneck entity.

11. The method of claim 10, wherein the method comprises:
generate, for transmission to the user, an optimal communication strategy corresponding to each of the one or more probable bottleneck entities in addition to the bottleneck entity.

12. The method of claim 9, wherein the optimal communication strategy indicates at least one of:
one or more optimal communication modes to be used for communicating with the bottleneck entity;
an optimal re-attempt frequency corresponding to each of the one or more optimal communication modes; and
a suggestion related to use of a third-party for communicating with the bottleneck entity.

13. The method of claim 9, wherein the method comprises:
identifying a particular location to which the bottleneck entity belongs;
obtaining real-time information about the particular location;
obtaining pre-defined information associated with the particular location; and
analyzing the real-time information and the pre-defined information to generate the optimal communication strategy.

14. The method of claim 9, wherein the method comprises:
ascertaining whether the bottleneck entity was identified as a bottleneck during any historical product recall performed by the organization;
upon ascertaining the bottleneck entity to have been identified as a bottleneck during a historical product recall, obtaining historical communication data describing a historical communication strategy implemented corresponding to the historical product recall for communicating with the bottleneck entity;
obtaining a current communication strategy initially utilized to communicate with the bottleneck entity when the product is recalled by the organization; and
analyzing the current communication strategy and the historical communication strategy to generate the optimal communication strategy for communicating with the bottleneck entity.

15. The method of claim 9, wherein the method comprises:
obtaining entity data describing each of the one or more entities;
anonymizing each of the one or more entities based on the entity data to generate one or more anonymized entities;
processing the distribution data and the one or more anonymized entities to generate an anonymized distribution path visually representing the movement of each of the plurality of units among the one or more anonymized entities; and
rendering the anonymized distribution path on a user interface.

16. A non-transitory computer-readable medium comprising instructions for managing product recall effectiveness, the instructions being executable by a processing resource to:
receive a bottleneck identification request in relation to a product recall action initiated by an organization to recall a plurality of units of a product;
obtain distribution data describing movement of each of the plurality of units among one or more entities involved in procurement and distribution of at least one of the plurality of units in a distribution chain of the product;
process the distribution data to identify a bottleneck entity, from the one or more entities, affecting recovery of the plurality of units of the product by the organization; and
generate, for transmission to a user, an optimal communication strategy for communicating with the bottleneck entity to enable recovery of the plurality of units of the product by the organization.

17. The non-transitory computer-readable medium of claim 16, wherein the instructions are executable by the processing resource to:
ascertain whether any entity of the one or more entities is in possession of at least one unit, from the plurality of units, of the product;
upon ascertaining a particular entity, of the one or more entities, to be in possession of at least one unit of the product, determine the particular entity to be one of one or more probable bottleneck entities affecting the recovery of the plurality of units;
determine a specific entity, from the one or more probable bottleneck entities, having a highest precedence in the distribution chain amongst the one or more probable bottleneck entities; and
designate the specific entity as the bottleneck entity.

18. The non-transitory computer-readable medium of claim 17, wherein the instructions are executable by the processing resource to:
generate, for transmission to the user, an optimal communication strategy corresponding to each of the one or more probable bottleneck entities in addition to the bottleneck entity.

19. The non-transitory computer-readable medium of claim 16, wherein the instructions are executable by the processing resource to:
identify a particular location to which the bottleneck entity belongs;
obtain real-time information about the particular location;
obtain pre-defined information associated with the particular location; and
analyze the real-time information and the pre-defined information to generate the optimal communication strategy.

20. The non-transitory computer-readable medium of claim 16, wherein the instructions are executable by the processing resource to:
ascertain whether the bottleneck entity was identified as a bottleneck during any historical product recall performed by the organization;
upon ascertaining the bottleneck entity to have been identified as a bottleneck during a historical product recall, obtain historical communication data describing a historical communication strategy implemented corresponding to the historical product recall for communicating with the bottleneck entity;
obtain a current communication strategy initially utilized to communicate with the bottleneck entity when the product is recalled by the organization; and
analyze the current communication strategy and the historical communication strategy to generate the optimal communication strategy for communicating with the bottleneck entity.
